(19) United States
(12) Patent Application Publication
(10) Pub. No.: US 2019/0379040 A1
(43) Pub. Date: Dec. 12, 2019

(54) Electrodes Including a Passivation Layer

(71) Applicant: The Johns Hopkins University, Baltimore, MD (US)

(72) Inventors: Konstantinos Gerasopoulos, Odenton, MD (US); Adam W. Freeman, Laurel, MD (US); Spencer A. Langevin, Columbia, MD (US); Chongyin Yang, College Park, MD (US); Chunsheng Wang, Silver Spring, MD (US)

(21) Appl. No.: 16/376,073

(22) Filed: Apr. 5, 2019

Related U.S. Application Data
(60) Provisional application No. 62/681,220, filed on Jun. 6, 2018.

(51) Int. Cl. H01M 4/36; H01M 10/0565; H01M 10/0569; H01M 10/0525; H01M 10/058; H01M 10/42

(52) U.S. Cl. CPC H01M 4/366; H01M 10/0565; H01M 10/4235; H01M 10/0525; H01M 10/058; H01M 10/0569

(57) ABSTRACT

Electrodes including a passivation layer formed prior to receiving an initial charge are provided. The electrodes comprise an electrode-composition including an active electrode species, in which the electrode-composition comprises a first surface. The electrodes also comprise a passivation layer positioned directly or indirectly onto at least a portion of the first surface. The passivation layer comprises a polymeric material and at least a first electrolyte. The electrodes can be included into an aqueous electrochemical cell. Methods of forming an electrode in the form of a thin layer or film are also provided. Methods of forming an aqueous electrochemical cell are also provided.

### CROSS-REFERENCE TO RELATED APPLICATIONS

This application claims priority under 35 U.S.C, §119(e) to U.S. Provisional Patent Application Ser. No. 62/681,220, filed on Jun. 6, 2018, which is expressly incorporated by reference herein in its entirety.

### STATEMENT REGARDING FEDERALLY SPONSORED RESEARCH OR DEVELOPMENT

Embodiments of the invention were made with Government support under contract number 18-C-0108 awarded by the National Reconnaissance Office. The Government has certain rights in the embodiments of the invention.

### TECHNICAL FIELD

Embodiments of the invention relate generally to electrodes including a passivation layer formed thereon prior to receiving an initial charge, in which the electrodes may be combined with aqueous-based electrolytes (e.g., liquid electrolytes, gel polymer electrolytes, etc.) and suppress the electrochemical activity of water. The passivation layer may comprise a polymeric material (e.g., cured or cross-linked polymeric material) and at least a first electrolyte (e.g., a lithium salt). Embodiments of the invention also relate to electrochemical cells (e.g., aqueous electrochemical cells) including one or more electrodes including a passivation layer formed thereon prior to receiving an initial charge.

### BACKGROUND

The majority of today's rechargeable batteries are based on lithium-ion chemistry. While lithium-ion batteries possess the highest practical energy density and cycle life among rechargeable systems, they suffer from safety concerns. A prominent safety concern is related to the organic solvents utilized in such batteries. While these organic solvents can support a wide electrochemical window and enable high energy density, they are flammable and volatile. When combined with an oxygen rich cathode, they increase the potential for thermal runaway and catastrophic failure. As a result batteries need to be thermally managed and hermetically packaged to ensure safety, which adds undesirable weight to the battery and limits lithium-ion battery architectures to rigid form factors (e.g., rigid casings, etc.). However, several commercial applications including autonomous systems, portable expeditionary power, and/or wearable/biomedical sensors require flexible, lightweight, and safe batteries that do not sacrifice energy density.

### BRIEF SUMMARY

Certain embodiments according to the invention provide an electrode comprising an electrode-composition including an active electrode species, in which the electrode-composition comprises a first surface, and a passivation layer positioned onto at least a portion of the first surface. In accordance with certain embodiments of the invention, the passivation layer may comprise a polymeric material and at least a first electrolyte.

In another aspect, embodiments of the present invention provide an electrochemical cell including an anode comprising an active anode species, a cathode comprising an active cathode species, and an aqueous-based electrolyte composition positioned between and in contact with the anode and the cathode. In accordance with certain embodiments of the invention, at least the anode includes a first passivation layer comprising a first polymeric material and at least a first electrolyte distributed throughout the first polymeric material. The first passivation layer may be positioned between the active anode species and the aqueous-based electrolyte composition.

In another aspect, embodiments of the present invention provide a method of forming an electrode. Such method, for instance, may include providing or forming an electrode-composition including an active electrode species, in which the electrode-composition comprises a first surface. The method may also include providing or forming a passivation-composition comprising a mixture of (a) a polymeric material and at least a first electrolyte in a liquid medium or (b) monomers and at least a first electrolyte in a liquid medium. The method may also include coating at least a portion of the first surface with the passivation-composition to provide a liquid-containing pre-passivation layer on at least a portion of the first surface. The method may also comprise at least one of drying or radically-curing the liquid-containing pre-passivation layer to form a passivation layer comprising a dry mixture of a cured polymeric material and the first electrolyte.

In another aspect, embodiments of the present invention provide a method of forming an electrochemical cell. The method may include providing or forming an anode comprising a first passivation layer defining a first anode-surface, providing or forming a cathode, and positioning an aqueous-based electrolyte composition between and in contact with the first anode-surface and the cathode.

### BRIEF DESCRIPTION OF THE DRAWINGS

Embodiments of the invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout, and wherein:

FIG. 1 illustrates an electrode including a passivation layer formed thereon in accordance with certain embodiments of the invention;

FIG. 2 illustrates an electrochemical cell according to certain embodiments of the invention;

FIG. 3 illustrates a cross-sectional view of the electrochemical cell of Figure

FIG. 4A illustrates a typical water contact angle for a hydrophilic substrate;

FIG. 4B illustrates a typical water contact angle for a hydrophobic substrate;

FIG. 5 illustrates a block diagram of a method for forming an electrode in accordance with certain embodiments of the invention;

FIG. 6 illustrates a block diagram of a method for forming an electrochemical cell in accordance with certain embodiments of the invention; and

FIG. 7A shows a 1st cycle for a comparative electrochemical cell;

FIG. 7B shows a 2^{nd} cycle for the comparative electrochemical cell of FIG. 7A;

FIG. 8A shows the 1st and 2nd cycles for an electrochemical cell according to certain embodiments of the invention;

FIG. 8B shows the capacity vs. cycle life of the same electrochemical cell represented in FIG. 8A;

FIG. 9 shows the 1st and 30^{th} cycles for an electrochemical cell without an electrode having a passivation layer formed thereon prior to the initial charge;

FIG. 10 shows the 1st and 30^{th} cycles for a different electrochemical cell without an electrode having a passivation layer formed thereon prior to the initial charge;

FIG. 11 shows the 1st and 20^{th} cycles for an electrochemical cell that is identical to the electrochemical cell of FIG. 10 with the exception that this electrochemical cell includes an anode having a passivation layer formed thereon prior to the initial charge in accordance with certain embodiments of the invention;

FIG. 12A shows the capacity and efficiency for (i) a first electrochemical cell without an electrode having a passivation layer formed thereon prior to the initial charge and (ii) a second electrochemical cell that is identical to the first electrochemical cell with the exception that the second electrochemical cell includes an anode having a passivation layer formed thereon prior to the initial charge in accordance with certain embodiments of the invention;

FIG. 12B shows the specific capacity and the coulombic efficiency for the first and second electrochemical cells of FIG. 12A;

FIG. 13A shows the in-situ Raman spectroscopy analysis for an electrochemical cell without an electrode having a passivation layer formed thereon prior to an initial charge in comparison with LiCO₃ during an initial charging cycle, in which water is consumed at the interface of the anode and gel polymer electrolyte (GPE) of the electrochemical cell;

FIG. 13B shows an enlarged portion of the in-situ. Raman spectroscopy analysis for the electrochemical cell of FIG. 13A during the initial charging cycle, in which the peak evolution matches the profile of a passivation layer;

FIG. 14A shows multiple cycles for a 4V electrochemical cell in accordance with certain embodiments of the invention;

FIG. 14B shows multiple cycles for another 4V electrochemical cell in accordance with certain embodiments of the invention;

FIG. 15 shows four images of passivation layers coated onto an electrode-composition, in which images labeled ‘c’ and ‘d’ illustrate a conformal coating of the electrode-composition;

FIG. 16 shows multiple cycles for an electrochemical cell in accordance with certain embodiments of the invention, in which the electrochemical cell includes an electrode having a cross-linked hydrophobic passivation formed thereon prior to receiving an initial charge;

FIG. 17 shows an initial cycle for an electrochemical cell in accordance with certain embodiments of the invention, in which the electrochemical cell includes an electrode having a cross-linked hydrophobic passivation formed thereon prior to receiving an initial charge;

FIG. 18A shows an initial cycle for an electrochemical cell in accordance with certain embodiments of the invention, in which the electrochemical cell includes an electrode having a cross-linked hydrophobic passivation formed thereon prior to receiving an initial charge;

FIG. 18B shows the capacity and efficiency for the electrochemical cell of FIG. 18A as a function of number of cycles;

FIG. 19 shows the initial two charge cycles for an electrochemical cell in accordance with certain embodiments of the invention;

FIG. 20A shows the initial two charge cycles for an electrochemical cell in accordance with certain embodiments of the invention;

FIG. 20B shows the efficiency and charge capacity as a function of cycle number for the electrochemical cell of FIG. 20A;

FIG. 21 shows the initial two charge cycles for another electrochemical cell in accordance with certain embodiments of the invention;

FIG. 22 shows the initial two charge cycles for another electrochemical cell in accordance with certain embodiments of the invention;

FIG. 23A shows the initial two charge cycles for an electrochemical cell in accordance with certain embodiments of the invention;

FIG. 23B shows the efficiency and charge capacity as a function of cycle number for the electrochemical cell of FIG. 23A;

FIG. 24A shows the initial charge cycles for a comparative electrochemical cell;

FIG. 24B shows the efficiency and charge capacity as a function of cycle number for the electrochemical cell of FIG. 24A;

FIG. 25A shows the initial charge cycles for another comparative electrochemical cell; and

FIG. 25B shows the efficiency and charge capacity as a function of cycle number for the electrochemical cell of FIG. 25A,

### DETAILED DESCRIPTION

Embodiments of the invention now will be described more fully hereinafter with reference to the accompanying drawings, in which some, but not all embodiments of the invention are shown. Indeed, the present invention may be embodied in many different forms and should not he construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

Aqueous-based electrolyte systems suitable for use in a variety of electrochemical cells may significantly reduce or mitigate the risk of thermal runaways leading to undesirable fires and explosions. Aqueous-based electrolyte systems suitable for use in a variety of flexible (e.g., non-rigid) electrochemical cells may be flexed or bent on an as-needed basis during or prior to operation. Electrochemical cells (e.g., aqueous electrochemical cells) including, for example, a gel polymer electrolyte (GPE) may continue to function after severe trauma or abuse (e.g., puncturing, cutting, etc.) to the electrochemical cell. In accordance with certain embodiments of the invention, electrochemical cells (e.g., aqueous electrochemical cells) including a cross-linked GPE suppress the electrochemical activity of water and subsequent decomposition gas generation at the anode and/or cathode. In this regard, however, some side reactions due to water activity/decomposition are still present particularly in initial cycles (e.g., initial charging and/or discharging). In accordance with certain embodiments of the invention, electrodes having a passivation layer formed thereon prior to receiving an initial charge are provided that further mitigate and/or reduce the undesirable water activity and/or decomposition at the anode and/or cathode. In this regard, the passivation layer inhibits or prevents water from mitigating to the active electrode species during operation within an electrochemical cell. In accordance with certain embodiments of the invention, a combination of an aqueous-based liquid electrolyte or GPE with one or more electrodes having a passivation layer significantly suppresses the electrochemical activity of water and further improves battery performance by increasing energy density and enhancing coulombic efficiency, which consequently improves cycle life and capacity retention.

Certain embodiments according to the invention provide an electrode comprising an electrode-composition including an active electrode species, in which the electrode-composition comprises a first surface, and a passivation layer positioned directly or indirectly onto at least a portion of the first surface. The passivation layer inhibits or prevents water from mitigating to the active electrode species during operation within an electrochemical cell. In accordance with certain embodiments of the invention, the passivation layer may comprise a polymeric material (e.g., a high molecular weight polymer, cured and/or cross-linked polymeric material) and at least a first electrolyte (e.g., a lithium salt). In accordance with certain embodiments of the invention, the passivation layer may comprise less than 10% by weight, such as less than 5% by weight, or less than 1% by weight of water, an organic solvent, or both. In accordance with certain embodiments of the invention, the passivation layer may be devoid of water, an organic solvent, or both. In accordance with certain embodiments of the invention, the passivation layer may comprise a dry admixture (e.g., a solid-in-solid material) of the first electrolyte distributed throughout the polymeric material (e.g., a high molecular weight polymer, cured and/or cross-linked polymeric material). The first electrolyte, in accordance with certain embodiments of the invention, may be homogeneously distributed throughout the polymeric material.

In accordance with certain embodiments of the invention, the first electrolyte may comprise from about 1% to about 40% by weight of the passivation layer on a dry basis, such as at most about any of the following: 40, 35, 30, 28, 25, 22, 20, 15, 12, 10, and 5% by weight of the passivation layer on a dry basis and/or at least about any of the following: 1, 2, 3, 5, 8, 10, 12, 15, and 20% by weight of the passivation layer on a dry basis. In accordance with certain embodiments of the invention, the polymeric material comprises from about 50% to about 99% by weight of the passivation layer on a dry basis, such as at most about any of the following: 99, 95, 90, 85, 80, 75, and 70% by weight of the passivation layer on a dry basis and/or at least about any of the following: 50, 55, 60, 65, 70, and 75% by weight of the passivation layer on a dry basis.

In accordance with certain embodiments of the invention, the active electrode species in the electrode-composition may comprise an active anode species or an active cathode species. The electrode-composition may also include one or more binders admixed with the active electrode species. For example, the electrode-composition may include a variety of binders suitable for use in electrode formation, such as poly(acrylic acid) (PAA) and copolymers thereof, styrene-butadiene rubber (SBR), and polyvinylidene fluoride (PVDF) based binders. Additionally or alternatively, a GPE-composition suitable for formation of an aqueous-based GPE may also be used as a binder component within the electrode-composition.

In accordance with certain embodiments of the invention, the passivation layer may comprise a second surface, a third surface, and a thickness, in which the second surface is adjacent or proximate to the first surface of the electrode-composition and the third surface is distal to the first surface of the electrode-composition. In this regard, the thickness of the passivation layer may be defined by a shortest distance between the second surface of the passivation layer and the third surface of the passivation layer. The thickness of the passivation layer, for instance, is particularly thin to minimize electrical impedance. In accordance with certain embodiments of the invention, the thickness of the passivation layer may comprise from about 0.05 to about 100 microns or from about 0.05 to about 50 microns, such as at most about any of the following: 100, 90, 80, 70, 60, 50, 40, 30, 20, 15, 10, 9, 8, 7, 6, 5, 4. 3, 2, and 1 microns and/or at least about any of the following: 0.05, 0.7, 0.9, 1, 2, 3, 4, 5, 10, and 20 microns.

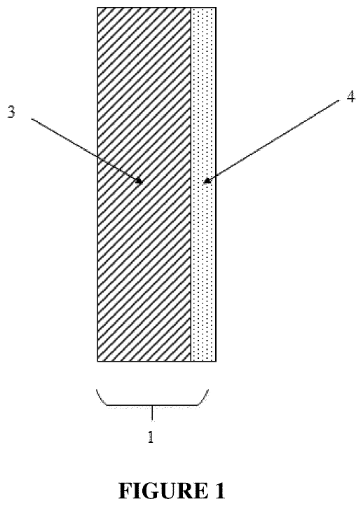

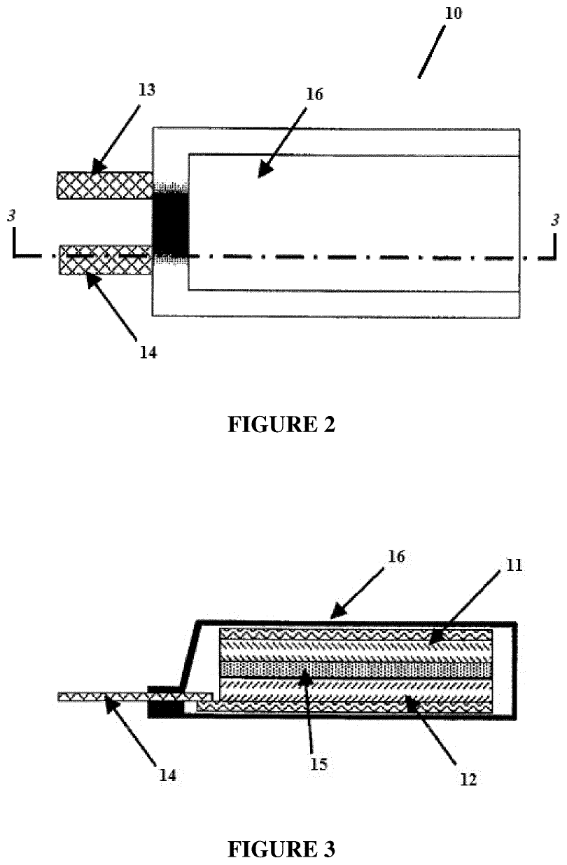

FIG. 1, for example, illustrates an electrode including a passivation layer formed thereon in accordance with certain embodiments of the invention. In particular, FIG. 1 illustrates electrode 1 including an electrode-composition 3 and a passivation layer 4 in contact with the electrode-composition 3. As illustrated in FIG. 1, the passivation layer may overlie and be in direct contact with the electrode-composition 3. As noted previously, electrodes having a passivation layer formed thereon prior to an initial charging may be incorporated into a variety of aqueous-based electrochemical cells. FIG. 2, for example, illustrates an exterior of an electrochemical cell 10 according to certain embodiments of the invention. As shown in FIG. 2, the electrochemical cell 10 may comprise battery container or housing 16, a cathode lead terminal 13 and an anode lead terminal 14. FIG. 3 illustrates a cross-sectional view of the electrochemical cell 10 of FIG. 2. As shown in FIG. 3, the electrochemical cell 10 comprises a cathode 11, an anode 12, and a GPE 15 that is disposed between and in contact with the cathode 11 and anode 12.

Although not illustrated in FIGS. 1-3, the passivation layer may comprise a dry admixture (e.g., a solid-in-solid material) of a first electrolyte distributed throughout the polymeric material (e.g., a high molecular weight polymer, cured and/or cross-linked polymeric material). The first electrolyte, in accordance with certain embodiments of the invention, may be homogeneously distributed throughout the polymeric material. :In accordance with certain embodiments of the invention, the first electrolyte may comprise a salt, such as a salt selected from a lithium salt or a zinc salt, or combination thereof. In accordance with certain embodiments of the invention, the first electrolyte may include a compound capable of generating an ion on being dissolved in a solvent (e.g., an aqueous solvent) including lithium salts such as lithium bis(oxalate)borate (LiBOB), lithium difluoro(oxalate)borate (LiDFOB), lithium methoxide (CH₃OLi), lithium hexafluorophosphate (LiPF₆), lithium tetrafluoroborate (LiBF₄), lithium hexafluoroarsenate (LiAsF₆), lithium perchlorate (LiClO₄), lithium trifluoromethanesulfonate (CF₃SO₃Li), lithium bis(trifluoromethanesulfonyl)imide (LiN(SO₂CF₃)₂), lithium bis(perfluoroethanesulfonyl)imide (LiN(SO₂C₂F₅)₂), tris(trifluoromethanesulfonyl)methyllithium (LiC(SO₂CF₃)₃), tris(perfluoroethanesulfonyl)methyllithium (LiC(SO₂C₂F₅)₃), lithium tetrachloroalutninate (LiAlCl₄), lithium hexafluorosilicate (Li₂SiF₆), and lithium dicyanamide (LiC₂N₃). Additionally or alternatively to lithium salts, the first electrolyte may be selected from sodium salts, magnesium salts, zinc salts, and calcium salts. In accordance with certain embodiments of the invention, the first electrolyte may comprise lithium bis(trifluoromethanesulfonyl)imide (LiTFSI), lithium trifluoromethanesulfonate (LiOTf), lithium chloride (LiCl), lithium perchlorate (LiClO₄), lithium bromide (LiBr), lithium iodide (LiI), lithium thiocyanate (LiSCN), lithium tetrafluoroborate (LiBF₄), lithium hexafluoroarsenate (LiAsF₆), lithium bis(oxalate)borate (LiBOB), lithium hexafluorophosphate (LiPF₆), a lithium polysulfide, zinc trifluoromethanesulfonate (Zn(OTf)₂), di[bis(trifluoromethanesulfonyl)imide) (Zn(TFSI)₂), lithium difluoro(oxalate)borate (LiDFOB), lithium methoxide (CH₃OLi), or combinations thereof.

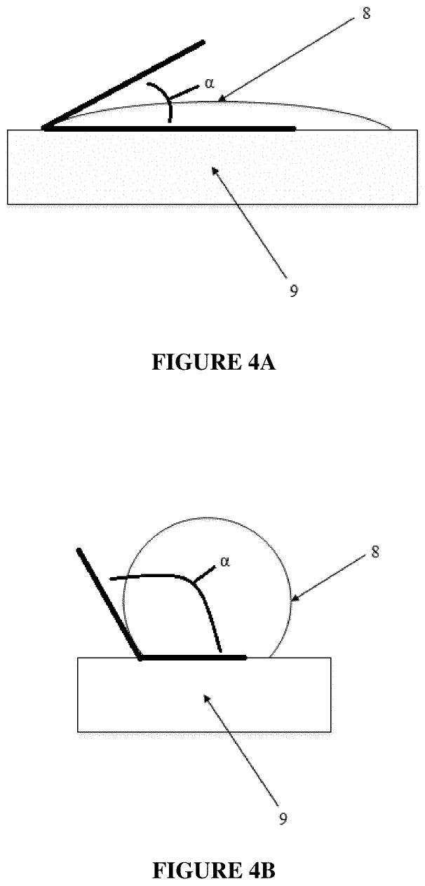

In accordance with certain embodiments of the invention, the polymeric material of the passivation layer may comprise a high molecular weight polymer or mixtures of one or more high molecular weight polymers, such as polyethylene oxide (PEO) or similar co-polymers with a salt (e.g., a lithium salt). In accordance with certain embodiments of the invention, the polymeric material comprises at least one high molecular weight polymer having a molecular weight from about 50,000 to about 10,000,000 g/mol, such as at most about any of the following: 10,000,000, 9,000,000, 8,000,000, 7,000,000, 6,000,000, 5,000,000, 4,000,000, 3000,000, 2,000,000, 1,000,000, 800,000, 600,000, 500,000, 400,000, 300,000, and 250,000 g/mol and/or at least about any of the following: 75,000, 100,000, 150,000, 200,000, 250,000, and 300,000 g/mol. In accordance with certain embodiments of the invention, the polymeric material of the passivation layer may comprise a hydrophilic polymer. Suitable hydrophilic polymers may comprise, for example, a poly(N-isopropylacrylamide), a polyacrylamide, a poly(N,N-dialkylacrylamide), a poly(2-oxazoline), a polyethyleneimine, a poly(acrylic acid), an alkali metal salt of poly(acrylic acid), a poly(meth)acrylate, a poly(ethylene glycol), a poly(ethylene oxide), a poly(vinyl alcohol), a poly(vinylpyrrolidine), poly(2-hydroxyethylacylate), poly(2-hydroxyethylmethacrylate), a poly(ethylene glycol) diacryl ate, copolymers (e.g., cross-linked or non-cross-linked) thereof, or combinations thereof. In accordance with certain embodiments of the invention, for example, the polymeric material may comprise a hydrophilic material comprising a cross-linked copolymer comprising a poly(ethylene glycol) diacrylate. In accordance with certain embodiments of the invention, due to the incorporation of the first electrolyte (e.g., a lithium salt) within a matrix of the dry polymeric material (e.g., no water and/or organic solvent is present), the electrode-active species utilization is significantly enhanced, improving the practically achievable energy density. Additionally, using this approach in accordance with certain embodiments of the invention, side reactions that are typically observed in the first cycle and are attributed to water decomposition are suppressed and the coulombic efficiency approaches 100%. In accordance with certain embodiments of the invention, the passivation layer may be devoid of water, an organic solvent, or both. In accordance with certain embodiments of the invention, the passivation layer comprises a hydrophilic surface that may be exposed or in contact with an aqueous-based electrolyte (e.g., aqueous-based GPE). FIG. 4A illustrates a water contact angle ‘α’ for a typical hydrophilic substrate, in which a liquid droplet 8 (e.g., water) spreads out across a substrate 9 and forms, for example, a water contact angle ‘α’ less than 90°. For comparison, FIG. 4B illustrates a water contact angle ‘α’ for a typical hydrophobic substrate, in which the liquid droplet 8 (e.g., water) forms a bead on the substrate 9 and forms, for example, a water contact angle ‘α’ greater than 90°.

In accordance with certain embodiments of the invention, the polymeric material comprises a hydrophobic polymer, which may be conductive to facilitate charge and ion migration across the passivation layer. In accordance with certain embodiments of the invention, the hydrophobic polymer comprises a cross-linked polymer formed from one or more monomers (e.g., one or more hydrophobic monomers). In accordance with certain embodiments of the invention, the hydrophobic polymer comprises a fluorinated polymer (e.g., a cross-linked polymeric material including a plurality of fluorine atoms). In accordance with certain embodiments of the invention, the polymeric material comprises a hydrophobic polymer and the resulting passivation layer may be devoid of fluorine atoms. In accordance with certain embodiments of the invention, the passivation layer may be devoid of water, an organic solvent, or both.

In accordance with certain embodiments of the invention, the polymeric material comprises a hydrophobic polymer comprising the reaction product of two or more of the following: (i) at least one polyfunctional crosslinking monomer including at least two free-radically polymerizable functional groups, (ii) at least one long chain monofunctional monomer, and optionally (iii) at least one fluorinated monomer. In accordance with certain embodiments of the invention, the polymeric material comprises a hydrophobic polymer comprising the reaction product of (i) at least one polyfunctional crosslinking monomer including at least two free-radically polymerizable functional groups and (ii) at least one long chain monofunctional monomer. In accordance with certain embodiments of the invention, for instance, the polymeric material comprises a hydrophobic polymer and the resulting passivation layer may be devoid of fluorine atoms. In accordance with certain embodiments of the invention, the passivation layer may be devoid of water, an organic solvent, or both.

The at least one polyfunctional crosslinking monomer (e.g., two or more free-radically polymerizable functional groups), for example, may comprise a long chain aliphatic monomer having from about 6 to about 40 carbon atoms, such as at most about any of the following: 40, 35, 30, 25, 20, 18, 16, 14, 12, and 10 carbon atoms and/or at least about any of the following: 6, 8, 10, 12, 14, and 16 carbon atoms. In accordance with certain embodiments of the invention, the at least two free-radically polymerizable functional groups of the at least one polyfunctional crosslinking monomer comprise one or two (meth)acrylate functional groups. Non-limiting examples of polyfunctional crosslinking monomers suitable for certain embodiments of the invention include the following:

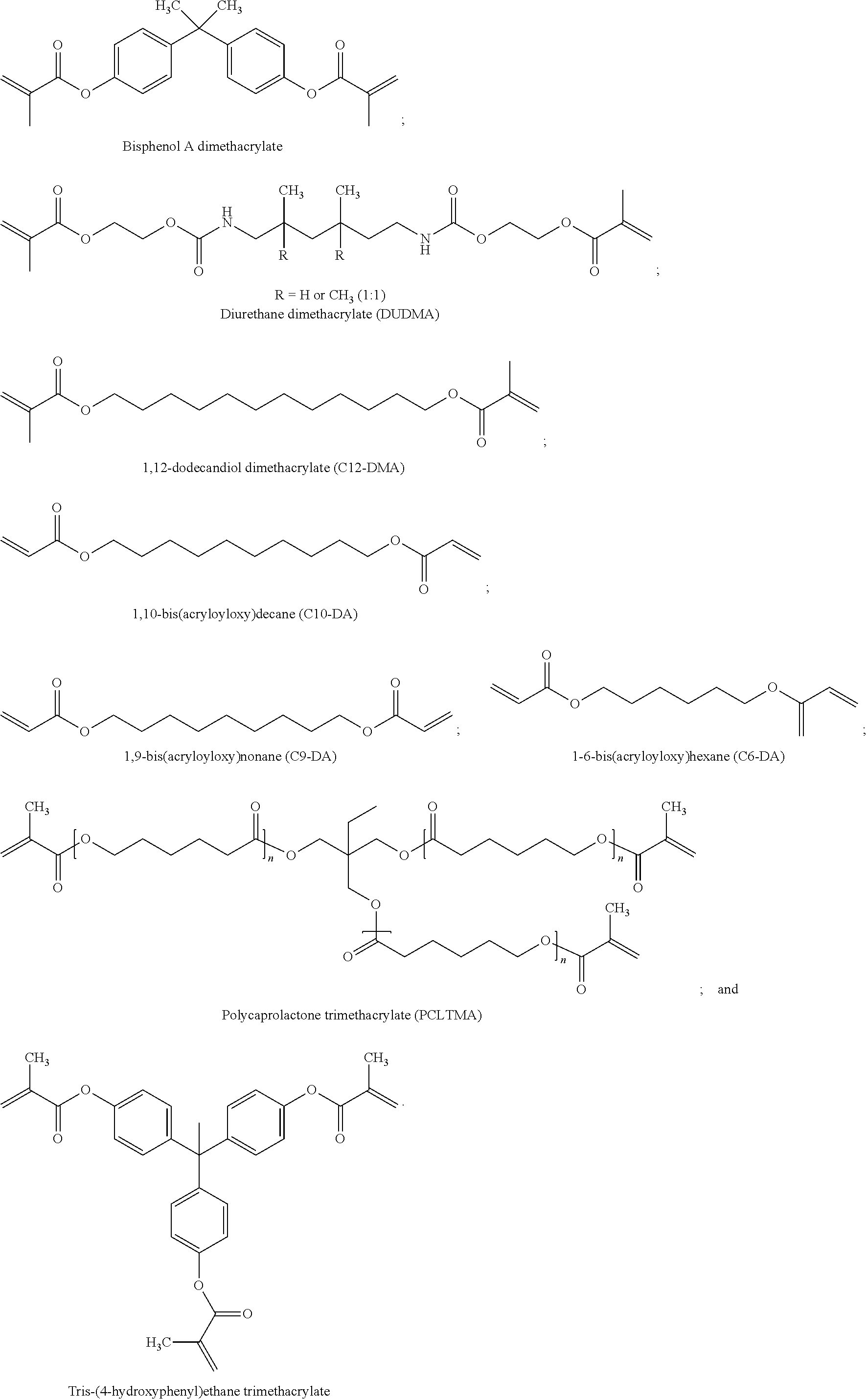

In accordance with certain embodiments of the invention, the at least one polyfunctional crosslinking monomer may comprise from about 1-60 wt. % of the total amount of monomers forming the polymeric material, such as from at most about any of the following: 60, 55, 50, 45, 40, 35, and 30 wt. % of the total amount of monomers forming the polymeric material and/or at least about any of the following: 1, 2, 3, 5, 8, 10, 12, 15, 18, 20, 22, 24, 26, 28, 30, and 35 wt. % of the total amount of monomers forming the polymeric material.

In accordance with certain embodiments of the invention, the at least one long chain monofunctional monomer may have from about 6 to about 40 carbon atoms, such as at most about any of the following: 40, 35, 30, 25, 20, 18, 16, 14, 12, and 10 carbon atoms and/or at least about any of the following: 6, 8, 10, 12, 14, and 16 carbon atoms. The at least one long chain monofunctional monomer, in accordance with certain embodiments of the invention, may comprise at least one free-radically polymerizable functional groups, such as an acrylate, methacrylate, acrylamide, styrene, or vinyl ether functional group. In accordance with certain embodiments of the invention, acrylates and methacrylates can be used interchangeably. A non-limiting example of a long chain monofunctional monomer suitable for certain embodiments of the invention include the following, in which for example acrylates and methacrylates can be used interchangeably:

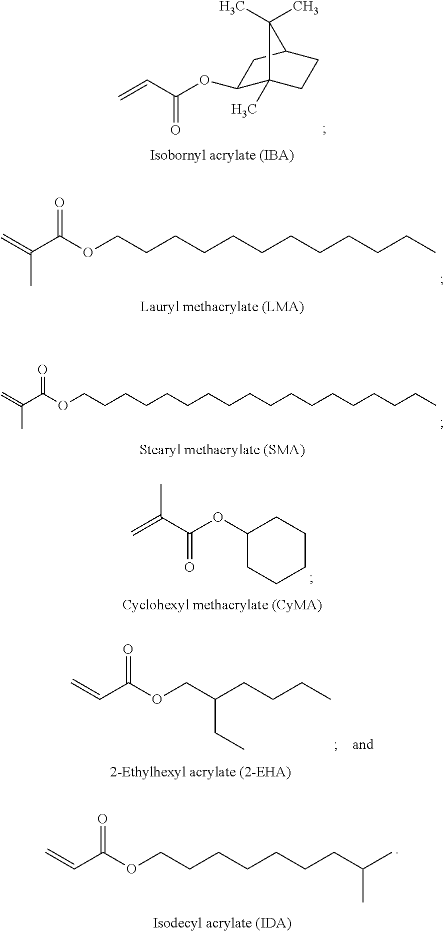

In accordance with certain embodiments of the invention, the at least one long chain monofunctional monomer may comprise from about 20-99 wt. %) of the total amount of monomers forming the polymeric material, such as from at most about any of the following: 99, 95, 90, 85, 80, 75, 70, 65, 60, 55, 50, 45, 40, 35, and 30 wt. % of the total amount of monomers forming the polymeric material and/or at least about any of the following: 20, 22, 24, 26, 28, 30, 35, 40, 45, 50, and 55 wt. % of the total amount of monomers forming the polymeric material.

In accordance with certain embodiments of the invention, the at least one fluorinated monomer may comprise from about 2 to about 40 carbon atoms, such as at most about any of the following: 40, 35, 30, 25, 20, 18, 16, 14, 12, and 10 carbon atoms and/or at least about any of the following: 2, 3, 4, 5, 6, 8, 10, 12, 14, and 16 carbon atoms. The at least one fluorinated monomer may also comprise from about 2 to about 40 fluorine atoms, such as at most about any of the following: 40, 35, 30, 25, 20, 18, 16, 14, 12, and 10 fluorine atoms and/or at least about any of the following: 2, 3, 4, 5, 6, 8, 10, 12, 14, and 16 fluorine atoms. The at least one fluorinated monomer, in accordance with certain embodiments of the invention, may comprise at least one free-radically polymerizable functional groups, such as an (meth)acrylate functional, methacrylate, acrylamide, styrene, or vinyl ether functional group. Non-limiting examples of the at least one fluorinated monomer suitable for certain embodiments of the invention include the following:

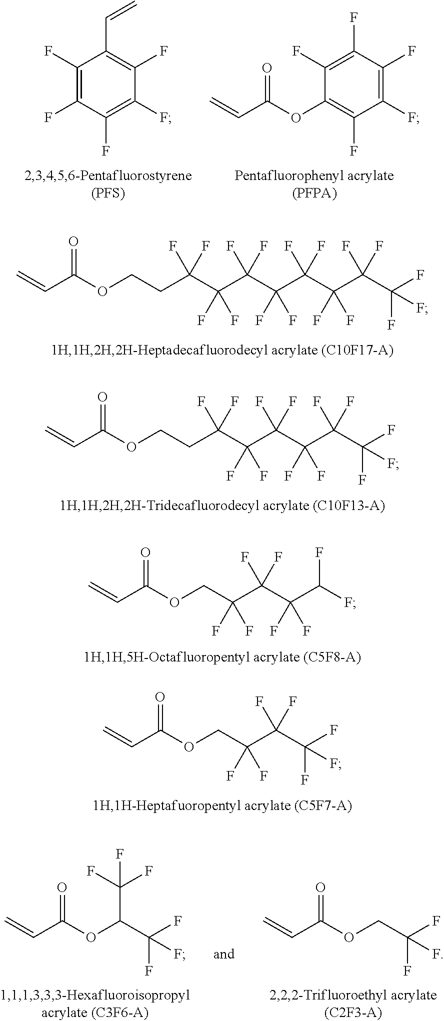

In accordance with certain embodiments of the invention, the at least one fluorinated monomer may comprise from about 1-30 wt. % of the total amount of monomers forming the polymeric material, such as from at most about any of the following: 30, 28, 24, 22, 20, 18, 16, 14, 12, 10, and 8 wt. % of the total amount of monomers forming the polymeric material and/or at least about any of the following: 1, 2, 3, 4, 5, 6, 7, 8, 9, and 10 wt. % of the total amount of monomers forming the polymeric material.

In accordance with certain embodiments of the invention, the pre-cured and/or pre-crosslinked polymeric material comprising the combination of monomers may also comprise a free radical initiator (e.g., chemical initiator, thermal initiator, photo-initiator, or redox initiation system), in which the free radical initiator may be present from about 0.1 to about 10 wt. % of the total monomer mass in the composition prior to being radically-cured. In accordance with certain embodiments of the invention, the free radical initiator may be present from at most about any of the following: 10, 9, 8, 7, 6, 5, 4, 3, 2, and 1 wt. % of the total monomer mass in the composition prior to being radically-cured and/or at least about any of the following: 0.1, 0.25, 0.5, 0.75, 1, 1.25, 1.5, 1.75, 2, 2.25, and 2.5 wt. % of the total monomer mass in the composition prior to being radically-cured.

Passivation layers in accordance with certain embodiments of the invention may be formed from a polymeric material or materials that comprise or consist of a hydrophobic polymer(s) (e.g., formed by a reaction product of monomers discussed above) and define a relatively hydrophobic surface that may be exposed or adjacent to an aqueous electrolyte (e.g., an aqueous GPE). In accordance with certain embodiments of the invention, the polymeric material or materials may be hydrophobic and provide water contact angles ‘α’ (for the polymeric material itself without the addition of salt-based electrolytes) from about 85 to about 120 degrees, such as about any of the following: 120, 115, 112, 110, 109, 108, 107, 106, 105, 104, 103, 102, 101, 100, 98, 96, 94, 92, and 90 degrees and/or at least about any of the following: 85, 86, 87, 88, 90, 92, 94, 96, 98, and 100 degrees. Static water contact angles can be measured using a Ramé-Hart Instruments goniometer as is known in the art

In another aspect, embodiments of the present invention provide electrochemical cells (e.g., aqueous-based electrochemical cell) including an anode comprising an active anode species, a cathode comprising an active cathode species, and an aqueous-based electrolyte composition positioned between and in contact with the anode and the cathode. In accordance with certain embodiments of the invention, the cathode may comprise the positive electrode and the anode may comprise the negative electrode, in which the cathode refers to the electrode where the reduction takes place during discharge and the anode refers to the electrode where oxidation takes place during discharge.

As used herein, the term “active anode species” may comprise any electrochemically active species associated with the anode. For example, the anode may comprise graphite, lithium, zinc, silicon, tin oxides, antimony oxides, or a lithium-containing material, such as lithium titanium oxide. In accordance with certain embodiments of the invention, the anode active species may comprise lithium metal or a lithium alloy. As used herein, the term “active cathode species” may comprise any electrochemically active species associated with the cathode. For example, the cathode may comprise a lithium metal oxide (e.g., a lithium-doped cobalt oxide, lithium-doped titanium oxide, lithium-doped nickel oxide, a lithium-doped manganese oxide, etc.), or a sulfur-containing material (e.g., elemental sulfur).

In accordance with certain embodiments of the invention, at least the anode includes a first passivation layer comprising a first polymeric material (e.g., a high molecular weight polymer, cured and/or cross-linked polymeric material) and at least a first electrolyte (e.g., a lithium salt) distributed throughout the first polymeric material. The first passivation layer, in accordance with certain embodiments of the invention, may be positioned directly or indirectly between the active anode species and the aqueous-based electrolyte composition (e.g., an aqueous-based GPE).

In accordance with certain embodiments of the invention, the cathode of the electrochemical cell also includes a passivation layer. For example, the anode may comprise the first passivation layer and the cathode may include a second passivation layer comprising a second polymeric material and at least a second electrolyte distributed throughout the second polymeric material. The second passivation layer may be positioned directly or indirectly between the active cathode species and the aqueous-based electrolyte composition (e.g., an aqueous GPE). FIG. 2, for example, illustrates an exterior of the electrochemical cell 10 according to certain embodiments of the invention. As shown in FIG. 2, the electrochemical cell 10 may comprise battery container or housing 16, cathode lead terminal 13 and anode lead terminal 14. FIG. 3 illustrates a cross-sectional view of the electrochemical cell 10 of FIG. 2. As shown in FIG. 3, the electrochemical cell comprises cathode 11, anode 12, and GPE 15 that is disposed between and in contact with the cathode 11 and anode 12.

In accordance with certain embodiments of the invention, the electrochemical cells may be provided in a variety of different shapes and forms and may comprise primary and secondary electrochemical cells. For instance, electrochemical cells in accordance with certain embodiments of the invention may comprise a rigid or non-rigid configuration. Non-rigid configurations, for example, may comprise an electrochemical cell that may be flexible such that the electrochemical cell's shape or configuration may be adjustable (e.g., movable between linear/flat configuration to an arcuate configuration) prior to or during operation. In accordance with certain embodiments of the invention, the electrochemical cells (e.g., aqueous electrochemical cells) may include one or more electrodes (e.g., anode and/or cathode) including a passivation layer as described herein.

In accordance with certain embodiments of the invention, the aqueous-based electrolyte composition may comprise less than 10% by weight, such less than 5% by weight, or less than 1% by weight of an organic solvent. In accordance with certain embodiments of the invention, the aqueous-based electrolyte composition may be devoid of an organic solvent.

In accordance with certain embodiments of the invention, the aqueous-based electrolyte composition comprises a GPE, in which the GPE comprises a GPE-composition comprising a cross-linked three-dimensional polymer network, an electrolyte absorbed by the GPE, and water. The electrolyte may comprise, in accordance with certain embodiments of the invention, a salt, such as a salt selected from a lithium salt or a zinc salt, or combination thereof. In accordance with certain embodiments of the invention, the electrolyte may include a compound capable of generating an ion on being dissolved in a solvent (e.g., an aqueous solvent) including lithium salts such as lithium hexafluorophosphate (LiPF6), lithium tetrafluoroborate (LiBF4), lithium hexafluoroarsenate (LiAsF6), lithium perchlorate (LiClO4), lithium trifluoromethanesulfonate (CH3SO3Li), lithium bis(trifluoromethanesulfonyl)imide (LiN(SO2CF3)2), lithium bis(perfluoroethanesulfonyl)imide (LiN(SO2C2F5)2), tris(trifluoromethanesulfonyl)methyllithium (LiC(SO2CF3)3), tris(perfluoroethanesulfonyl)methyllithium (LiC(SO2C2F5)3), lithium tetrachloroaluminate (LiAlCl4), lithium hexafluorosilicate (Li2SiF6), and lithium dicyanamide (LiC2N3). Additionally or alternatively to lithium salts, the electrolyte may be selected from sodium salts, magnesium salts, zinc salts, and calcium salts. In accordance with certain embodiments of the invention, the electrolyte may comprise lithium bis(trifluoromethanesulfonyl)imide (LiTFSi), lithium trifluoromethanesulfonate (LiOTf), lithium chloride (LiCl), lithium perchlorate (LiClO4), lithium bromide (LiBr), lithium iodide (LiI), lithium thiocyanate (LiSCN), lithium tetrafluoroborate (LiBF4), lithium hexafluoroarsenate (LiAsF6), lithium bis(oxalate)borate (LiBOB), lithium difluoro(oxalate)borate (LiDFOB), lithium hexafluorophosphate (LiPF6), a lithium polysulfide, zinc trifluoromethanesulfonate (Zn(OTf)2), di[bis(trifluoromethanesulfonyl)imide) (Zn(TFSI)2), or combinations thereof.

In accordance with certain embodiments of the invention, the electrochemical cell has not received an initial charge and/or discharge.

The aqueous-based composition may comprise an aqueous-based GPE comprising a single layer or multiple layers and still be considered to be in contact with both the anode and cathode. In accordance with certain embodiments of the invention, the GPE includes a GPE-composition comprising (a) a cross-linked three-dimensional polymer network and (b) an electrolyte and water absorbed by the GPE.

In accordance with certain embodiments of the invention, the electrochemical cells may comprise an operational voltage window from about 1 to about 6 volts, such as at most about any of the following: 6, 5.5, 5, 4.5, 4, 3.5, 3, and 2.5 volts and/or at least about any of the following: 1, 1.25, 1.5, 1.75, 2, 2.25, 2.5, 2.75, 3, 3.25, 3.5, 3.75, and 4 volts.

In accordance with certain embodiments of the invention, the electrochemical cells comprise a particularly improved energy density per unit mass of the electrochemical cell. In one aspect, the aqueous electrochemical cells disclosed herein do not need significant housing requirements and other added safety components used to mitigate thermal runaways associated with organic-based electrochemical cells. The reduced weight, especially coupled with the added safety associated with an aqueous electrochemical cell, may be particularly desirable in any application in which weight reduction is of importance, such as in automobiles, aircraft, aerospace applications, military equipment, and hiking equipment to name a few. In accordance with certain embodiments of the invention, the electrochemical cells may comprise energy density per unit mass of the electrochemical cell from about 0.2 to about 0.8 such as at most about any of the following: 0.8, 0.7, 0.6, 0.5, 0.4, 0.3, 0.275, 0.25, , and 0.225 MJ/Kg and/or at least about any of the following: 0.2, 0.225, 0.25, 0.275, 0.3, 0.35, and 0.4 MJ/Kg.

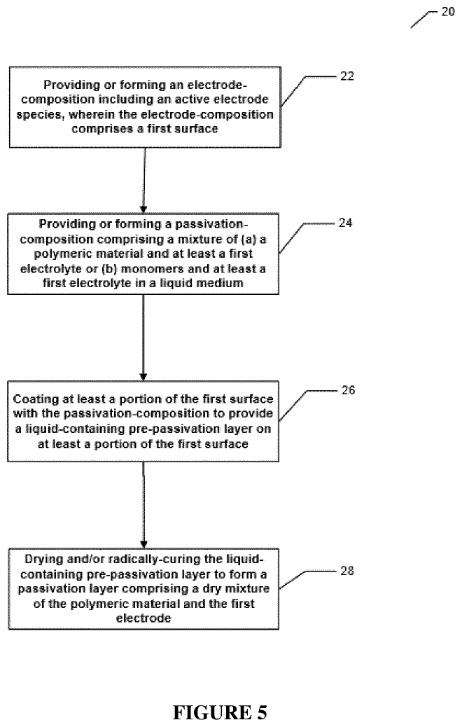

In another aspect, embodiments of the present invention provide methods of forming an electrode. FIG. 5 for example, illustrates that such methods 20 may include providing or forming an electrode-composition including an active electrode species, in which the electrode-composition comprises a first surface at operation 22. The methods of forming an electrode may also include providing or forming a passivation-composition comprising a mixture of (a) a polymeric material (e.g., a high molecular weight polymer) and at least a first electrolyte (e,g., a lithium salt) in a liquid medium (e.g., as a solution, slurry, or suspension) or (b) monomers and at least a first electrolyte (e.g., a lithium salt) in a liquid medium (e.g., as a solution, slurry, or suspension) at operation 24. In accordance with certain embodiments of the invention, the methods may include coating at least a portion of the first surface with the passivation-composition to provide a liquid-containing pre-passivation layer on at least a portion of the first surface at operation 26. The methods may also comprise drying and/or radically curing the liquid-containing pre-passivation layer to form a passivation layer comprising a dry mixture of a cured polymeric material (e.g., dry high molecular weight polymer and/or a radically cured, cross-linked polymeric material) and the first electrolyte (e.g., a lithium salt) at operation 28.

In accordance with certain embodiments of the invention, drying the liquid-containing pre-passivation layer may comprise subjecting this layer to conditions sufficient to ensure the passivation layer comprises less than 10% by weight, such as less than 5% by weight, or less than 1% by weight of water, an organic solvent, or both. In accordance with certain embodiments of the invention, the passivation layer may be devoid of water, an organic solvent, or both.

In accordance with certain embodiments of the invention, the operation of providing or forming a passivation-composition comprising a mixture of a polymeric material (e.g., a high molecular weight polymer) and at least a first electrolyte (e.g., a lithium salt) in a liquid medium may comprise one or more high molecular weight polymers as described herein along with one or more salts described herein dissolved in an appropriate solvent. For example, the high molecular weight polymer may comprise a high molecular weight polyethylene oxide (PEO) and the first electrolyte may comprise a lithium salt dissolved in an organic solvent (e.g., acetonitrile). In accordance with certain embodiments of the invention, the polymeric material of the passivation layer may comprise a hydrophilic polymer. Suitable hydrophilic polymers may comprise, for example, a poly(N-isopropylacrylamide), an N,N-dimethylacrylamide, an alkali metal salt of poly(acrylic acid), a polyacrylamide, a poly(2-oxazoline), a polyethyleneimine, a poly(acrylic acid), a poly(meth)acrylate, a poly(ethylene glycol), a poly(ethylene oxide), a poly(vinyl alcohol), a poly(vinylpyrrolidine), poly(2-hydroxyethyl) acrylate, poly(2-hydroxyethyl) methacrylate, poly(oligoethyleneglycol) acrylate copolymers thereof, or combinations thereof. The resulting liquid material including the one or more high molecular weight polymer and the first electrolyte may be dried, for example, in an oven (e.g., either alone or already coated onto an electrode-composition of an electrode) for a sufficient period of time (e.g., 24 hours or more) to remove most or all of the organic solvent to provide a dry admixture of the one or more high molecular weight polymer and the first electrolyte as described herein. In accordance with certain embodiments of the invention, the resulting dry admixture (e.g., a solid-in-solid material) may then be coated onto an electrode-composition (e.g., active electrode material alone or in combination with a binder) to provide an electrode including a passivation layer thereon.

In accordance with certain embodiments of the invention, the operation of providing or forming a passivation-composition comprising monomers, such as those described above, and at least a first electrolyte (e.g., a lithium salt) in a liquid medium (e.g., as a solution, slurry, or suspension) may comprise admixing two or more of the following: (i) at least one polyfunctional crosslinking monomer including at least two free-radically polymerizable functional groups, (ii) at least one long chain monofunctional monomer, and optionally (iii) at least one fluorinated monomer. In accordance with certain embodiments of the invention the admixture may comprise (i) at least one polyfunctional crosslinking monomer including at least two free-radically polymerizable functional groups and (ii) at least one long chain monofunctional monomer. In accordance with certain embodiments of the invention, for instance, the admixture and the resulting passivation layer may he devoid of fluorine atoms. In accordance with certain embodiments of the invention, the admixture may also include a free radical initiator (e.g., chemical initiator, thermal initiator, photo-initiator, or redox initiation system), in which the free radical initiator may be present from about 0.1 to about 10 wt. % of the total monomer mass in the composition prior to being radically-cured. In accordance with certain embodiments of the invention, the free radical initiator may be present from at most about any of the following: 10, 9, 8, 7, 6, 5, 4, 3, 2, and 1 wt. % of the total monomer mass in the composition prior to being radically-cured and/or at least about any of the following: 0.1, 0.25, 0.5, 0.75, 1, 1.25, 1.5, 1.75, 2, 2.25, and 2.5 wt. % of the total monomer mass in the composition prior to being radically-cured. In accordance with certain embodiments of the invention the admixture of the monomers, the first electrolyte, and the free radical initiator may be applied directly or indirectly onto an electrode-composition (e.g., active electrode material alone or in combination with a binder) to provide an electrode including a liquid-containing passivation-composition that is ready for cross-linking and/or curing. In accordance with certain embodiment of the invention, the step of drying the liquid-containing pre-passivation layer to form the passivation layer may comprises radically-curing an aqueous composition of the mixture of monomers (e.g., admixture of monomers, first electrolyte, and free radical initiator). In accordance with certain embodiments of the invention, the thickness of the applied layer (e.g., coating of the liquid-containing pre-passivation layer to form the passivation layer) may be controlled by placing a transparent cover on top the uncured admixture supported by a spacer. In this regard, the liquid-containing pre-passivation layer may be irradiated and/or heated to cure liquid-containing pre-passivation layer and remove the liquid (e.g., water and/or organic solvent) to form the passivation layer. Other methods of application of the passivation layer to the electrode may include dip coating, blade coating, spin coating, and spray coating, as well as other printing techniques such as stencil printing, screen printing, droplet printing, aerosol jet printing and extrusion printing.

In accordance with certain embodiments of the invention, the coating of the at least a first portion of the first surface with the passivation-composition (e.g., a mixture of a polymeric material and at least a first electrolyte in a liquid medium and/or a mixture of monomers and at least a first electrolyte in a liquid medium) may comprise placing a layer of the passivation-composition on top of at least a portion of the first surface of the electrode-composition and applying a slight pressure or external force (e.g., via a direct air stream or weight) to the passivation-composition to facilitate penetration of the passivation-composition into the body of the electrode-composition. In accordance with certain embodiments of the invention, the application of pressure to the passivation-composition may comprise a positive pressure (e.g., via a direct air stream or weight) or a negative pressure (e.g., application of a vacuum to draw or pull the passivation-composition into the body or pores of the electrode-composition). For example, the electrode-composition may comprise a porous structure having a plurality of pores extending from the surface of the electrode-composition into the body of the electrode-composition. In accordance with certain embodiments of the invention, the passivation-composition may be allowed for forced (e.g., applying a slight pressure or external force onto the passivation-composition to facilitate entry of the passivation-composition into the pores) into and fill at least a portion of the pores to provide a more conformal coating layer of the passivation-composition. In accordance with certain embodiments of the invention, the passivation-composition may be subjected to a drying operation (e.g. solvent evaporation) and/or cross-linking operation after the passivation-composition has filled and/or entered at least a portion of the pores of the electrode-composition to provide a conformally coated passivation layer.

In accordance with certain embodiments of the invention, drying the liquid-containing pre-passivation layer may comprise subjecting this layer to conditions sufficient to ensure the passivation layer comprises less than 10% by weight, such as less than 5% by weight, or less than 1% by weight of water, an organic solvent, or both. In accordance with certain embodiments of the invention, the passivation layer may be devoid of water, an organic solvent, or both.

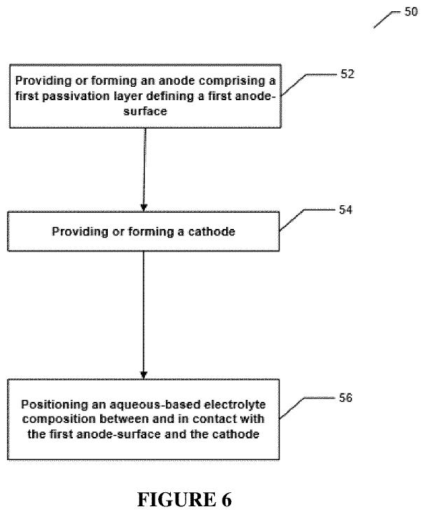

In another aspect,embodiments of the present invention provide methods of forming an electrochemical cell. FIG. 6, for example, illustrates a method 50 that may include providing or forming an anode comprising a first passivation layer, as described herein, defining a first anode-surface at operation 52. The method 50 may also comprise providing or forming a cathode, as described herein, at operation 54, and positioning an aqueous-based electrolyte composition between and in contact with the first anode-surface and the cathode at operation 56. In accordance with certain embodiments of the invention, the method may comprise providing or forming a cathode comprising a second passivation layer defining a first cathode-surface, and depositing the aqueous-based electrolyte composition between and in contact with the first anode-surface and the first cathode-surface. In accordance with certain embodiments of the invention, the methods may comprise subjecting the first passivation layer, the second passivation layer, or both to a drying operation as described herein either before or after assembly of the electrochemical cell. For example, one or both of the first or second passivation layers may be subjected to a drying operation as described herein before the aqueous-based electrolyte composition (e.g., aqueous-based GPE) is positioned between and in contact with the anode and cathode. Additionally or alternatively, the drying operation may be performed after the aqueous-based electrolyte composition (e.g., aqueous-based GPE) is positioned between and in contact with the anode and cathode. For example, any liquid-containing passivation-composition (e.g., uncured or not cross-linked) may be radically cured after the aqueous-based electrolyte composition (e.g., aqueous-based GPE) is positioned between and in contact with the anode and cathode.

In accordance with certain embodiments of the invention, the aqueous-based. electrolyte composition may comprise a GPE. The GPE, in accordance with certain embodiments of the invention, may comprise a GPE-composition comprising a cross-linked three-dimensional polymer network, an electrolyte absorbed by the GPE, and water.

### EXAMPLES

The present disclosure is further illustrated by the following examples, which in no way should be construed as being limiting. That is, the specific features described in the following examples are merely illustrative and not limiting.

### Example Set 1

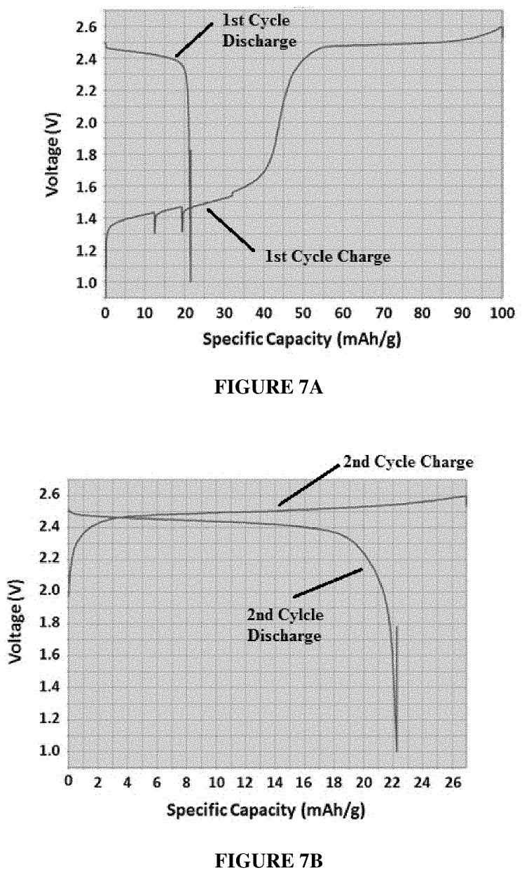

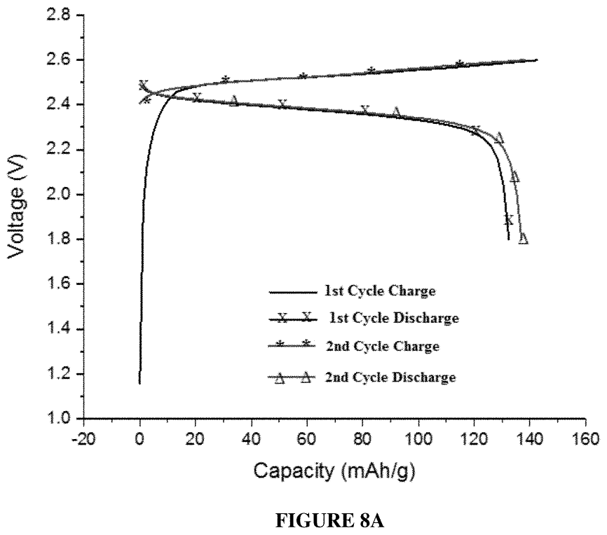

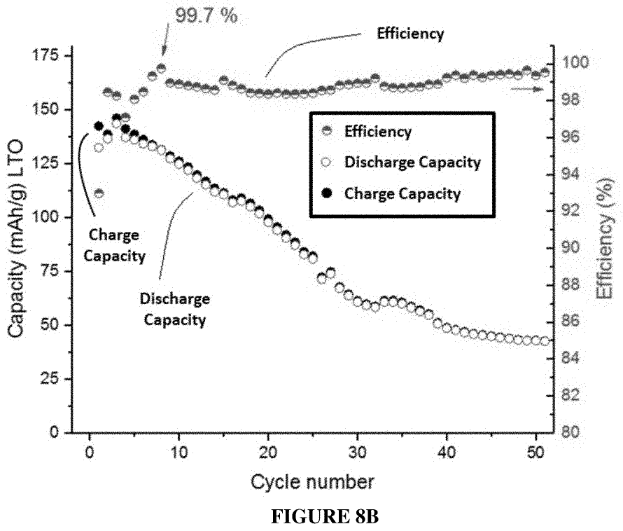

An electrochemical cell having a lithium-titanium oxide (LTO) anode and a Lithium Manganese Oxide (LMO) cathode. The electrolyte was a hydroxyl ethyl acrylate(HEA)/Poly(ethylene glycol) diacrylate (PEGDA) provided in a 99:1 weight ratio of HEA to PEGDA. The HEA/PEGDA accounted for 30 wt. % of the electrolyte with the remaining 70 wt. % was accounted for by water-in-bisalt material. The LTO anode was 2,4 mg in total, which was pre-coated with a passivation-composition including 20 wt. % LiTFSI and 80 wt. % PEO (1M) in acetonitrile. The passivation-composition was subjected to a drying operation to provide a dry passivation layer on the LTO anode. FIGS. 7A and 7B show the first and second cycles, respectively, of a comparative cell without a passivation layer formed prior to the first charge. As can he seen, there is a voltage plateau during the charge cycle around 1.4 V to 1.7 V. This plateau is attributed to water decomposition at the electrode and significantly reduces coulombic efficiency, and thus cycle life, in the first cycle. The plateau disappears at the second cycle. FIG. 8A shows the 1st and 2nd cycles for the electrochemical cell and FIG. 8B shows the capacity vs. cycle life of the electrochemical cell having a passivation layer formed prior to the first charge. As can be seen, the first charge cycle shows that the water decomposition plateau associated with the comparative cell is already gone. In this regard, instead of “spending” the first cycle to form a dry polymer interface, the cell of FIGS. 8A and 8B included a coating or passivation layer formed on the electrode prior to an initial charge, and as a result, the cell does not sacrifice capacity in the first cycle. Thus, the starting coulombic efficiency is higher and the cells last longer.

### Example Set 2

A variety of free-standing passivation films were fabricated and tested for flexibility, toughness, and contact angle. A summary of the free-standing passivation films are summarized in Table 1 below. The abbreviations for the various monomers forming the free-standing polymer passivation layers have been defined earlier. In this regard, the flexibility and toughness values were qualitatively evaluated on a scale of 0-10 with a score of ‘10’ being better than a score of ‘0’. For example, a flexibility score of ‘10’ indicates that the stand-alone passivation layer was capable of being bent so that the ends of the stand-alone passivation layer touch without cracking. A score of ‘10’ for toughness indicates that stand-alone passivation layer was not able to be pulled apart (e.g., torn) by hand. Static water contact angles were measured using a Rance-Hart Instruments goniometer as is known in the art.

TABLE 1

| Passivation Layer Monomer Constituents (wt %) | | | | | | | Properties | | |
|---|---|---|---|---|---|---|---|---|---|
| Sample | C12-DMA | C9-DA | IDA | C10F17-A | C2F3-A | PEGDA-700 | Flexibility | Toughness | Contact Angle |
| 1 | 100 | — | — | — | — | — | 0 | 10 | — |
| 2 | 90 | — | 10 | — | — | — | 2 | 10 | — |
| 3 | 80 | — | 20 | — | — | — | 4 | 10 | — |
| 4 | 90 | — | 9 | 1 | — | — | 3 | 10 | — |
| 5 | 90 | — | 9 | — | 1 | — | 4 | 10 | — |
| 6 | 90 | — | — | — | 10 | — | 0 | 10 | — |
| 7 | 80 | — | 19 | 1 | — | — | 5 | 10 | — |
| 8 | 80 | — | 19 | — | 1 | — | 4 | 10 | — |
| 9 | 20 | — | 80 | — | — | — | 9 | 2 | — |
| 10 | 10 | — | 90 | — | — | — | 10 | 0 | — |
| 11 | 40 | — | 60 | — | — | — | 8 | 8 | — |
| 12 | 60 | — | 40 | — | — | — | 6 | 8 | — |
| 13 | 50 | — | 50 | — | — | — | 8 | 10 | 87.2, 88.2 |
| 14 | — | 50 | 50 | — | — | — | 7 | 10 | 89.8, 89.9 |
| 15 | 50 | | 40 | — | 10 | — | 8 | 10 | 98.5, 99.6 |
| 16 | — | 50 | 40 | — | 10 | — | 7 | 10 | 95.5, 94.2 |
| 17 | 50 | | 48 | 2 | — | — | 8 | 10 | 104.2, 105.5 |
| 18 | — | 50 | 48 | 2 | — | — | 8 | 10 | 102.4, 103.4 |
| 19 | — | — | — | — | — | 100 | 10 | — | — |
| 20 | 50 | — | — | — | 50 | — | 5 | 10 | 102.7, 104.2 |
| 21 | 50 | — | 45 | 5 | — | — | 8 | 10 | 106.2, 105.8 |

*Composition was used for 28 wt. % and 14 wt. % LiTFSI studies

As can be seen from the data in Table 1, sample numbers 11, 13-18, and 21 concomitantly provided excellent flexibility and toughness.

### Example Set 3

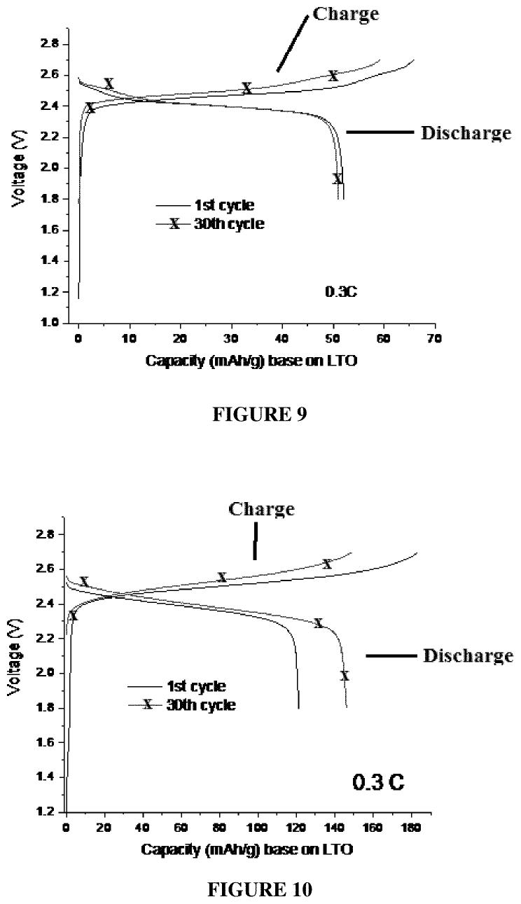

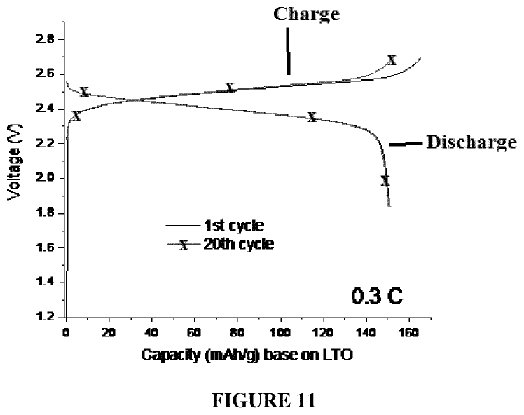

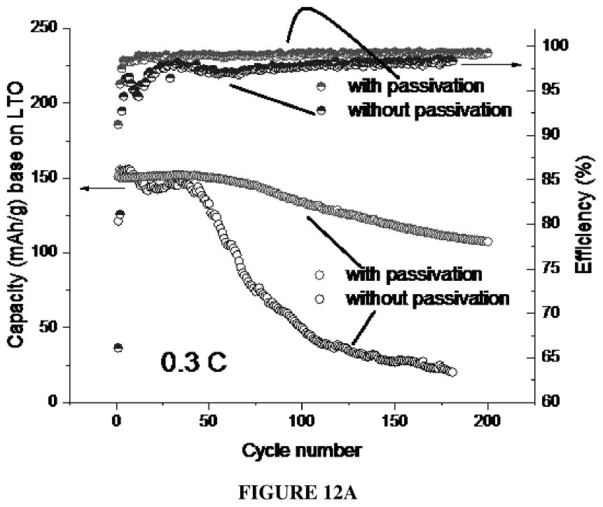

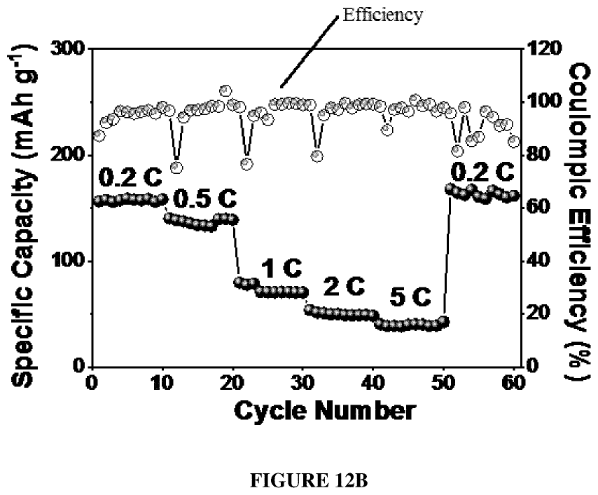

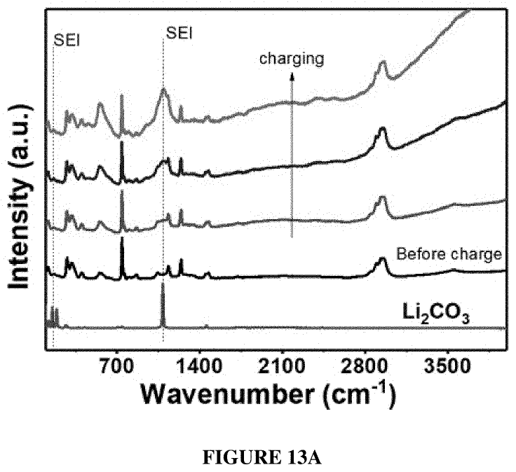

FIGS. 9 and 10 each show the 1st and 30th cycles for LTO/LMC) electrochemical cells without an electrode having a passivation layer formed thereon prior to receiving an initial charge. In particular, the electrochemical cell of FIG. 9 included a HEA:PEGDA (99:1) at 70 wt. % and 30 wt. % water-in-bisalt electrolyte. FIG. 10 included a HEA:MPEGDA:PEGDA (9:99:1) at 70 wt. % and 30 wt. % water-in-bisalt electrolyte. As can be seen in FIGS. 9 and 10, the voltage of the initial cycle charges in both electrochemical cells lagged below that of later cycle charges. To the contrary, an electrochemical cell identical to that of FIG. 10 was assembled, but include a passivation layer disposed on the LTO anode prior to receiving an initial charge. The passivation layer comprised HEA:MPEGA:PEGDA (9:90:1) at 70 wt. % and 30 wt. % LiTFSI, which shows that the passivation composition can be formed using polymers containing low levels of cross-linkers. FIG. 11 shows the 1st and 20th cycles for this electrochemical cell (i.e., includes the passivation layer on the LTO anode). As can be seen in FIG. 11, the voltage of the initial cycle charge and the 20^{th} cycle charge were nearly identical. Not only does the electrochemical cell of FIG. 11 provide an increased voltage on early cycle charges, FIG. 12A shows the capacity and efficiency for (i) the electrochemical cell of FIG. 10 (e.g., without an electrode having a passivation layer formed thereon prior to the initial charge) and (ii) the electrochemical cell of FIG. 11 (e.g., the LTO anode includes a passivation layer formed thereon prior to the initial charge). FIG. 12B shows the specific capacity and the coulombic efficiency for (i) the electrochemical cell of FIG. 10 (e.g., without an electrode having a passivation layer formed thereon prior to the initial charge) and (ii) the electrochemical cell of FIG. 11 (e.g., the LTO anode includes a passivation layer formed thereon prior to the initial charge).

### Example Set 4

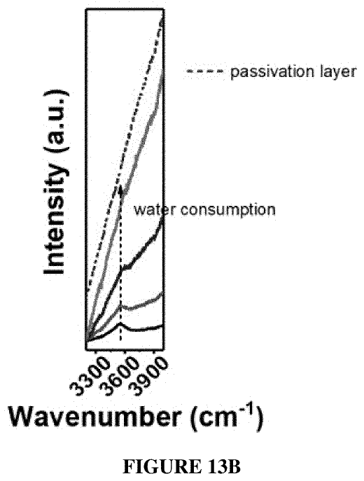

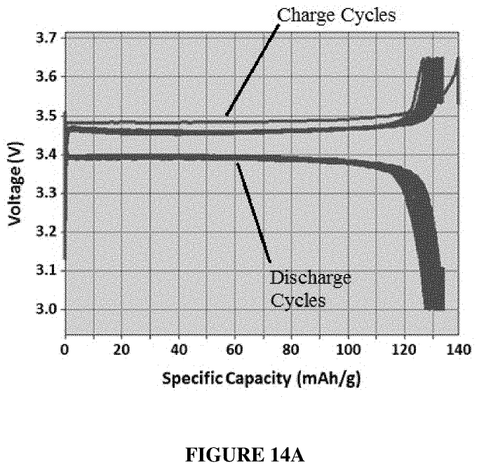

The previous working and non-exhaustive examples highlight several beneficial aspects of incorporating passivation layers into aqueous-based electrochemical cells in accordance with certain embodiments of the invention. FIGS. 13A and 13B provide a visual explanation for at least some of these readily realized benefits. FIG. 13A, for example, shows the in-situ Raman spectroscopy analysis for an electrochemical cell without an electrode having a passivation layer formed thereon prior to an initial charge in comparison with Li₂CO₃ during an initial charging cycle, in which water is consumed at the interface of the anode and electrolyte (e.g., GPE) of the electrochemical cell. In particular, the electrochemical cell of FIG. 13A included a MPEGAHEA:PEGDA (90:9:1) at 70 wt. % and 30 wt. % water-in-bisalt electrolyte. Transparent glass was used as the working electrode with LMO as the counter and reference electrode. FIG. 13B shows an enlarged portion of the in-situ. Raman spectroscopy analysis for the electrochemical cell of FIG. 13A during the initial charging cycle. FIGS. 13A and 13B show that in an electrochemical cell without an electrode including a passivation layer(i.e., prior to initial charging), water is consumed at the interface of the electrolyte (e.g., GPE) and electrode interface and eventually forms a dry polymer. FIG. 13B shows that peak evolution matches the profile of a passivation layer. In this regard, certain embodiments of the invention including a passivation layer formed on one or both electrodes prior to initial charges enables electrochemical cells to not compromise capacity in the initial cycles and achieve great full cell performance as illustrated in the previous passivation layer-containing examples.

### Example Set 5

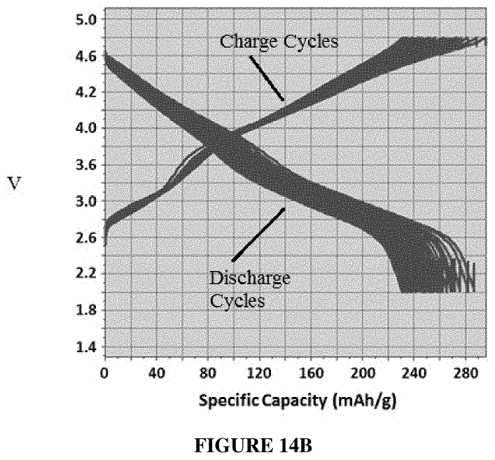

A couple 4V electrochemical cells, in accordance with certain embodiments of the invention, were fabricated for analysis. FIG. 14A shows multiple cycles for a first 4V electrochemical cell (i.e., Li—LiFePO₄ cell) in accordance with certain embodiments of the invention. The first 4V electrochemical cell included an anode (e.g., Li metal) having a dry passivation layer comprising LiTFSiI and lithium bis(oxalate)borate (LiBOB) mixed salt dispersed within a cross-linked PEGDA matrix. The passivation layer for formed from a liquid passivation-composition comprising 70 wt. % PEGDA, 28 wt. % LiTFSI, and 2 wt. % LiBOB without a photo-initiator. The anode was soaked in the liquid passivation composition for 5 hours after degassing in a vacuum chamber. Then a resulting free-standing (or stand-alone) GPE was laminated on top of the soaked anode and exposed to UV light to polymerize the passivation-composition into the dry passivation layer. FIG. 14B shows multiple cycles for a second 4V electrochemical cell (i.e., C—Li_{1.2}Mn_{0.54}Co_{0.13}Ni_{0.13}O₂ cell) in accordance with certain embodiments of the invention. The second 4V electrochemical cell included the same GPE and passivation layer on the anode, but the second 4V electrochemical cell also included an identical passivation layer formed on the cathode prior to an initial charging cycle.

### Example Set 6

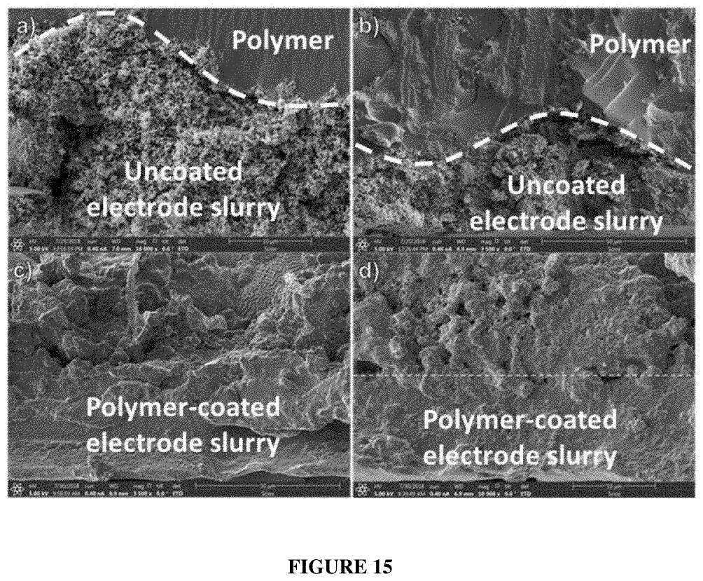

A series of passivation studies were conducted to monitor penetration of the passivation layer into the porous structure of the electrode-composition initial passivation layers were attempted by coating the electrode with a PEGDA monomer layer and letting the monomer mixture sit overnight before UV curing in order to allow the polymer to penetrate into the porous electrode-composition over time. Image ‘a’ on FIG. 15 shows that despite the length of time there was no penetration of the polymer into the porous electrode-composition layer. Secondary attempts were made with a PEGDA solution left overnight with a glass slide pressing on top of the polymer to apply pressure to assist the polymer diffusion into the porous layer and minimize the polymer thickness on top of the electrode-composition. This method also showed no penetration into the porous electrode, as shown in image ‘b’ of FIG. 15, and the thickness of the passivation layer on top of the electrode-composition could not be controlled well below about ˜50 μm. Finally a method was developed in which the pre-polymer solution (e.g., passivation-composition) was placed on top of the electrode-composition and then an air stream was directed on the top of the sample. The air stream served to force polymer into the pores of the electrode-composition and blow off excess polymer from the surface resulting in a highly conformal coating which penetrates fully through the electrode-composition. This process showed sufficient penetration and conformability regardless of the length of time the polymer sat on the electrode-composition surface and with multiple different polymer compositions. Examples with PEGDA and C12DMA/IDA polymer are shown in images ‘c’ and ‘d’, respectively. This example set, for instance, shows that the method of using an air stream to remove excess passivation solution drives the mixtures into the pores whether they are hydrophobic or hydrophilic in nature.

### Example Set 7

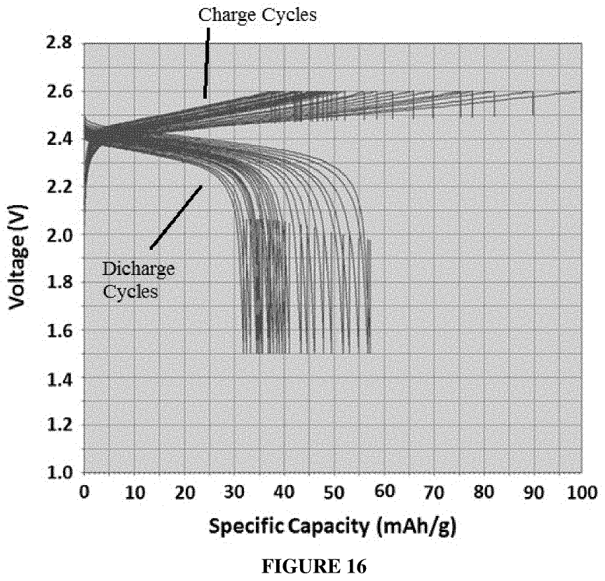

FIG. 16 shows multiple cycles for an electrochemical cell in accordance with certain embodiments of the invention, in which the electrochemical cell includes an electrode having a cross-linked hydrophobic passivation formed thereon prior to receiving an initial charge. The electrochemical cell included a passivation layer, which was formed thereon before receiving an initial charge, formed from a passivation-composition including 50 wt. % of 1,9-Bis(acryloyloxy)nonane (C9DA) and 50 wt. % isodecyl acrylate (IDA) as the polymer matrix. LiTFSI at a 30 wt. % concentration was also added to the passivation-composition. The LTO anode (obtained from NEI Corporation) was allowed to soak in the above mixture overnight. The electrode was then exposed to UV light for 30 seconds and then dried in an oven overnight. Finally, a standard GPE with 99:1 HEA:PEGDA recipe was pressed on top of the LTO followed by LMO attachment. This example demonstrates that cross-linked hydrophobic passivation layers that do not contain fluorinated monomers work well. This example also shows that high levels of cross-linker can be used in passivation.

### Example Set 8

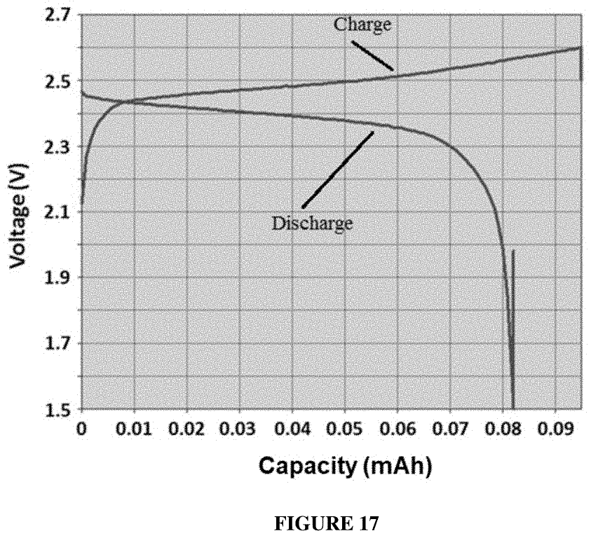

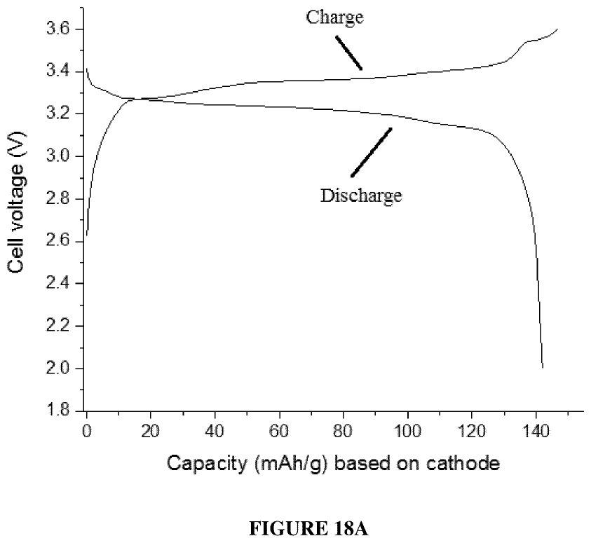

FIG. 17 shows an initial cycle for an electrochemical cell in accordance with certain embodiments of the invention, in which the electrochemical cell includes an electrode having a cross-linked hydrophobic passivation formed thereon prior to receiving an initial charge. This electrochemical cell was fabricated in the same manner as that of Example set 7, This electrochemical cell included an anode (i.e., Nanomyte-LTO 4.15 mg/cm²), cathode (i.e., Nanomyte-LMO 7.76 mg/cm²), and a GPE (i.e., 99:1 HEA:PEGDA matrix at 30 wt. %+70 wt. % WiBS) between the anode and cathode. The anode included a passivation layer formed thereon, which included a 50:50 C9DA:IDA matrix at 70 wt. %+30 wt. % LiTFSI). In this regard, this example illustrates that cross-linked hydrophobic passivation layers (e.g., the polymeric matrix being hydrophobic) that are devoid of fluorinated monomers work well.

### Example Set 9

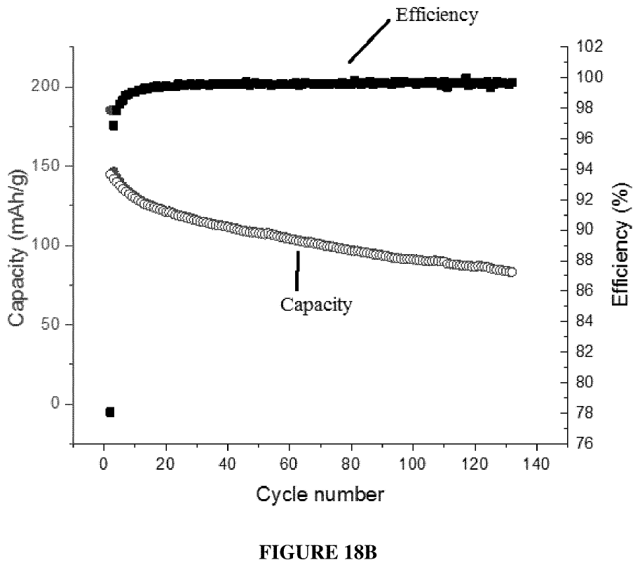

FIG. 18A shows an initial cycle for an electrochemical cell in accordance with certain embodiments of the invention, in which the electrochemical cell includes an electrode having a cross-linked hydrophobic passivation formed thereon prior to receiving an initial charge. The anode comprised a graphite loading of 3.2 mg/pc and the cathode comprised a LFPO loading of 1.9 mg/pc. The electrochemical cell also included a GPE between the cathode and anode. The GPE comprised 99 wt. % of HEA, 1 wt % of PEGDA, and 30 wt. % water-in-bisalt. The passivation layer of the anode comprised 40 wt. % PEGDA, 30 wt. % LiTFSI, and 30 wt. % of hydrofluoroether (HIT). FIG. 18B shows the capacity and efficiency for the electrochemical cell of FIG. 18A as a function of number of cycles.

### Example Set 10

A variety of different passivation films with differing LiTFSI levels (i.e., Examples 1-4 in Table 2) were constructed and tested for conductivity. Table 2 provides a summary for the different passivation films (i.e., Examples 1-4) and their corresponding conductivity.

TABLE 2

| | | | | | Conductivity (S/cm) | |
|---|---|---|---|---|---|---|
| Passivation Layer Monomer Constituents (wt %) | | | | | (a) | (b) |
| Example | HEA | MPEGA | PEGDA | TMPETA | +30 wt % LiTFSI | + 50 wt % LiTFSI |
| 1 | 9 | 90 | 1 | — | 4.43 × 10⁻⁵ | — |
| 2 | — | — | 100 | — | 3.01 × 10⁻⁷ | — |
| 3 | — | 98 | 2 | — | — | 1.10 × 10⁻⁴ |
| 4 | — | — | — | 100 | 9.48 × 10⁻⁸ | 1.73 × 10⁻⁴ |

HEA = 2-hydroxylethyl acrylate;
MPEGA = poly(ethylene glycol) methyl ether acrylate, Mₙ = 480;
PEGDA = poly(ethylene glycol) diacrylate, Mₙ = 700;
TMPETA = trimethylolpropane ethoxylate triacrylate;
LiTFSI = lithium bis(trifluoromethanesulfonyl)imide

Table 2 shows that LiTFSI-containing passivation layers can be formulated from various ethoxylated monomers, and that conductivities of the resulting films increases with increasing LiTFSI levels. Passivation compositions having conductivities >10⁻⁸ S/cm have been shown to produce functioning batteries. Passivation formulations having conductivities of 10⁻⁵ S/cm may be preferred. Polymer compositions contain crosslinker levels from 1-100% (PEGDA, TMPETA), with compositions containing lower levels of crosslinker having generally higher conductivities for the same LiTFSI level.

The passivation films of Table 2 were incorporated into electrochemical cells. For passivation formulations containing up to 30% LiTFSI from Table 2, the electrochemical cell included a passivation layer, which was formed thereon before receiving an initial charge, formed from a passivation-composition including the compositions shown in Table 2 as the polymer matrix and 0.5 wt. % (relative to total monomer mass) Irgacure 819 as a photoinitiator. LiTFSI at a 30 wt. % concentration (relative to total polymer mass) was also added to the passivation-composition. Organic solvents were optionally added to aid in dissolution and subsequent electrode penetration. The LTO anode (4.6 mg active loading) was allowed to soak in the above mixture for at least 10 minutes. The electrodes were removed from the solution, stripped of excess passivation solution, then exposed to UV light for 30 seconds. The coated electrodes were then optionally dried in an oven at 85-100° C. for at least 15 minutes. After cooling, the LTO electrode was then topped with the indicated pre-cured GPE recipe, and subsequently topped with an LMO cathode (8.2 mg active loading). Alternatively, the GPE could be cured directly on top of the LMO cathode before being placed on top of the passivation-coated LTO. The resulting sandwich structures were then placed in a coin cell case for testing.

For passivation formulations containing up to 50% LiTFSI from Table 2, the passivation formulations containing 50% LiTFSI were prepared and used as described in the preceding paragraph, except that organic solvents (e.g. acetone, acetonitrile, tetrahydrofuran, methyl ethyl ketone, ethyl acetate, methanol) (10-20 wt. % relative to total monomer and LiTFSI mass) was added to the monomer-LiTFSI mixtures to aid in the dissolution of the salt. The organic solvents were later evaporated from the UV cured passivation layers during the subsequent oven drying step.

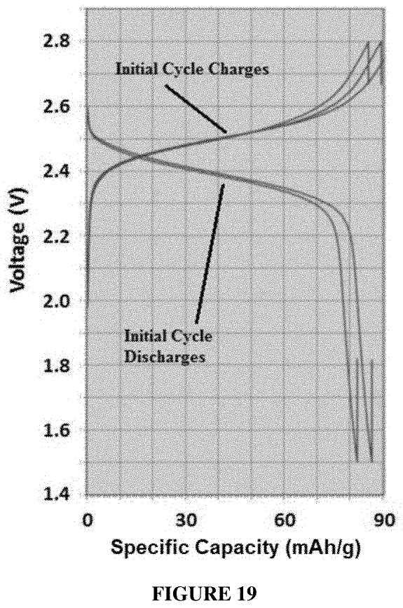

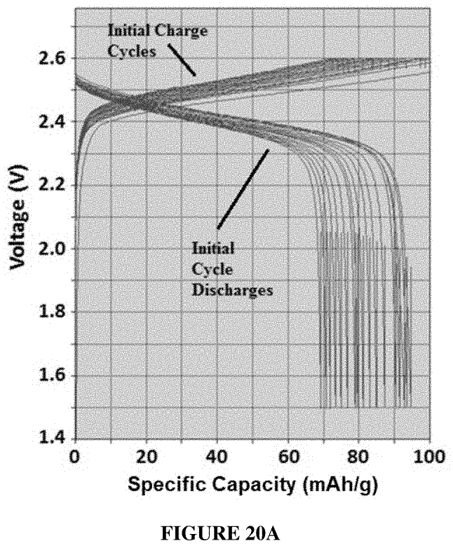

FIG. 19 shows the first two charge cycles for an electrochemical cell incorporating a passivation layer from Example 1(a) from Table 2. The data shown in FIG. 19 shows that electrochemical cells made using LTO-topped with 90 MPEGA/9 HEA/1 PEGDA-based passivation (containing 30 wt. % LiTFSI) exhibit cell cycles having high efficiency, and very high charge and discharge capacities. The electrochemical cell had the following construction: Cathode: LMO (8.2 mg); Anode: LTO (4.6 mg); GPE: 75% 28 m WiBS+25% (90 MPEGA/9 HEA/1 PEGDA). The passivation layer was cast from acetone (50 wt. %), cured by irradiation (365 nm, 0.25W for 30 seconds), then dried at 100° C. for 30 min before cell assembly. In this regard, this data also shows that passivation coatings cast from organic solvents lead to efficient cells.

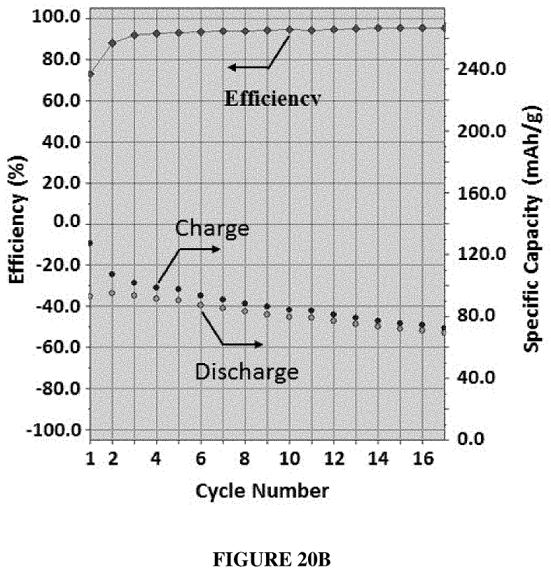

FIGS. 20A and 20B show the initial charge/discharge cycles for an electrochemical cell made using LTO-topped with 98 MPEGA/2 PEGDA-based passivation (containing 50 wt. % LiTFSI) (i.e., Example 3(b) from Table 2) exhibit cell cycles having high efficiency shown in FIG. 20B, and very high charge and discharge capacities. The capacity fade was low for this electrochemical cell. The electrochemical cell had the following construction: Cathode: LMO (8.2 mg); Anode: LTO (4.6 mg), GPE: 70% 28 in WiBS+30% (90 MPEGA/9 HEA/1 PEGDA).

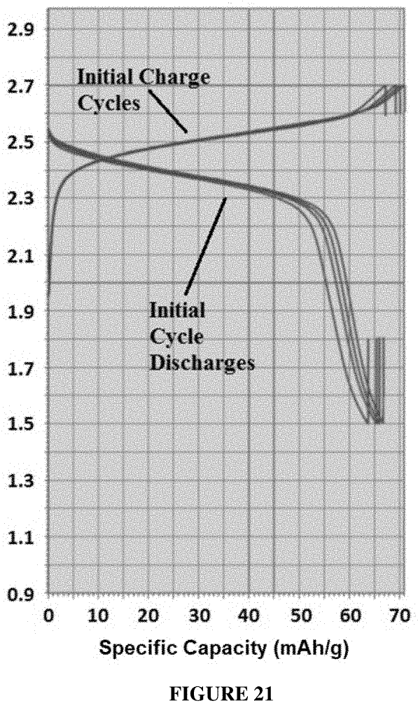

FIG. 21 shows the first initial charge cycles for an electrochemical cell incorporating a passivation layer from Example 3(a) from Table 2. The data shown in FIG. 21 shows that electrochemical cells made using LTO-topped with 98 MPEGA/2 PEGDA-based passivation (containing 30 wt % LiTFSI) exhibit cell cycles having high efficiency, and high charge and discharge capacities. The electrochemical cell had the following construction: Cathode: LMO (8.2 mg); Anode: LTO (4.6 mg); GPE: 70% 28 m WiBS+30% (90 MPEGA/9 HEA/1 PEGDA). The passivation layer was cast from acetonitrile (50 wt %), cured by irradiation (365 nm, 0.25W for 30 seconds), then dried at 85° C. for 30 min before cell assembly. In this regard, this data also shows that passivation coatings cast from organic solvents may lead to efficient cells.

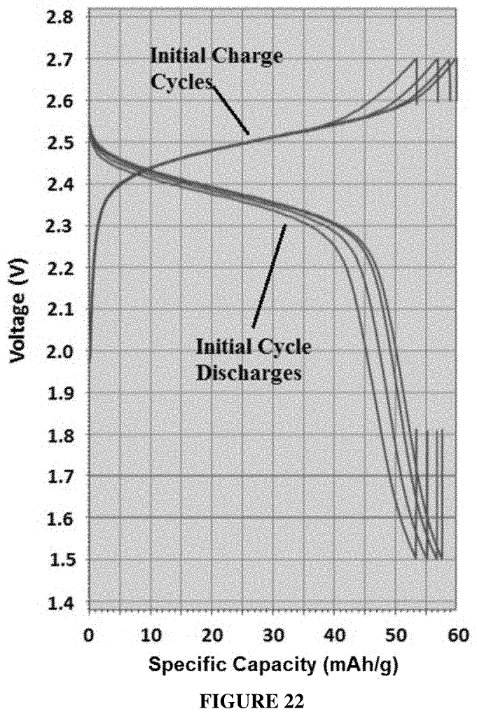

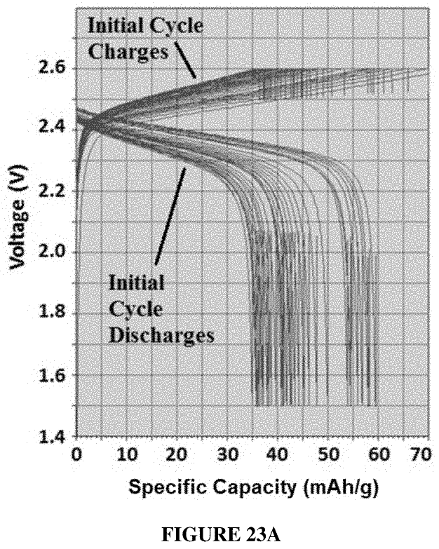

FIG. 22 shows the first initial charge cycles for an electrochemical cell incorporating a passivation layer from Example 3(b) from Table 2. The data shown in FIG. 22 shows that electrochemical cells made using LTO-topped with 98 MPEGA/2 PEGDA-based passivation (containing 50 wt. % LiTFSI) exhibits cell cycles having high efficiency, and high charge and discharge capacities. The electrochemical cell had the following construction: Cathode: LMO (8.2 mg); Anode: LTO (4.6 mg); GPE: 70% 28 m WiBS+30% (90 MPEGA/9 HEA/1 PEGDA.). The passivation layer was applied by soaking the electrode in the monomer solution for 15 min, and removing the excess by blotting with a lint-free towel. The passivation layer was then cured by irradiation (365 nm, 0.25W for 30 seconds), then dried at 85° C. for 30 min before cell assembly. This data also shows that passivation coatings cast from organic solvents may lead to efficient cells.

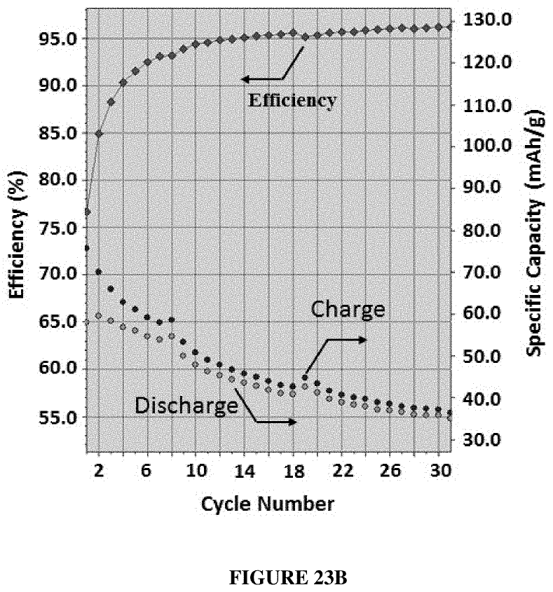

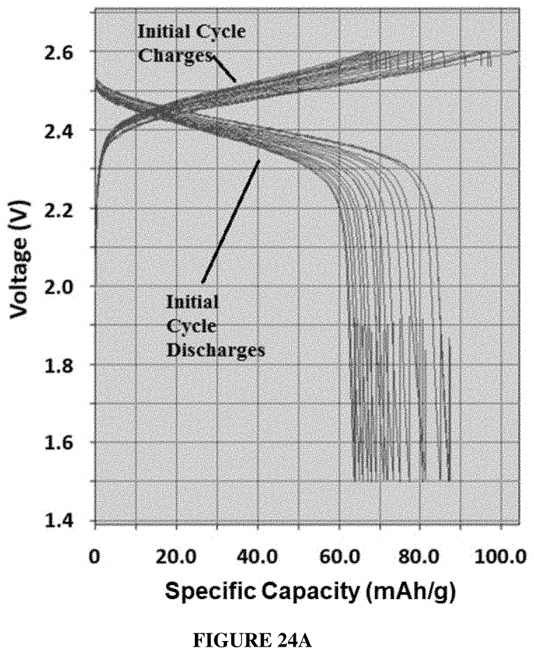

FIGS. 23A and 23B show the initial charge/discharge cycles for an electrochemical cell made using LTO-topped with 100 TMPETA-based passivation (containing 50 wt % LiTFSI) (i.e., Example 4(b) from Table 2) exhibits high efficiency as shown in FIG. 23B, and high charge and discharge capacities. The electrochemical cell had the following construction: Cathode: LMO (8.2 mg); Anode: LTO (4.6 mg); GPE: 70% 28 m WiBS+30% (90 MPEGA/9 HEA/1 PEGDA).

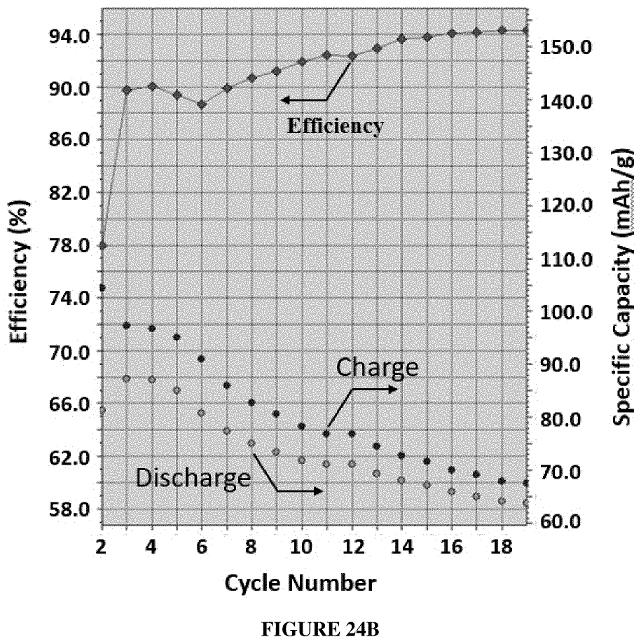

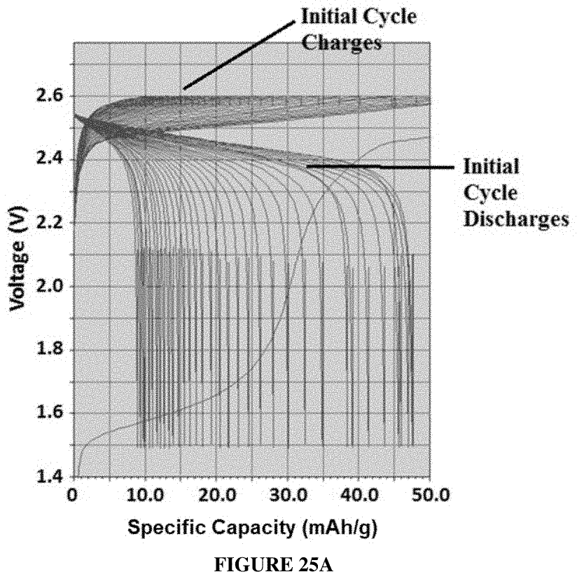

FIGS. 24A and 24B illustrate data for a comparative electrochemical cell made without a passivation layer. FIGS. 24A and 24B show that electrochemical cells made without LTO-topped passivation can be cycled, but have lower efficiencies and faster capacity fade than comparable electrochemical cells using passivation layers, such as Examples 1 and 2 from Table 2. This comparative electrochemical cell had the following construction: Cathode: LMO (8.2 mg); Anode: LTO (4.6 mg); GPE: 70% 28 m WiBS±30% (90 MPEGA/9 HEA/1 PEGDA).

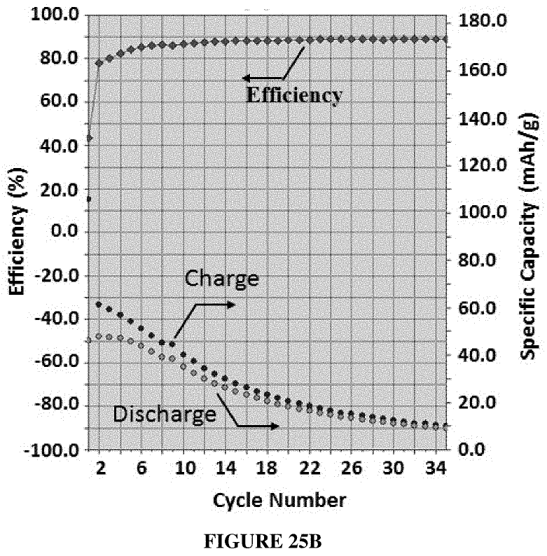

FIGS. 25A and 25B illustrate data for another comparative electrochemical cell made without a passivation layer. FIGS. 25A and 25B show that electrochemical cells made without LTO-topped passivation can be cycled, but have lower efficiencies and faster capacity fade than comparable electrochemical cells using passivation layers, such Examples 1-4 from Table 2. This comparative electrochemical cell had the following construction: Cathode: LMO (8.2 mg); Anode: LTO (4.6 mg); GPE: 70% 28 m WiBS+30% (49.5 MPEGA/49.5 HEA/1 PEGDA). This comparative example is similar to previous comparative example (e.g., FIGS. 24A and 24B) except that it uses a different GPE.

These and other modifications and variations to embodiments of the invention may be practiced by those of ordinary skill in the art without departing from the spirit and scope of the invention, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the invention as further described in such appended claims. Therefore, the spirit and scope of the appended claims should not be limited to the exemplary description of the versions contained herein.

That which is claimed:

1. An electrode, comprising:
(i) an electrode-composition including an active electrode species, wherein the electrode-composition comprises a first surface; and
(ii) a passivation layer positioned onto at least a portion of the first surface, said passivation layer comprising a polymeric material and at least a first electrolyte.

2. The electrode of claim 1, wherein the passivation layer is devoid of water, organic solvents, or both.

3. The electrode of claim 1, wherein the active electrode species comprises an active anode species or an active cathode species.

4. The electrode of claim 1, wherein the passivation layer comprises a thickness comprising from about 0.05 to about 100 microns.

5. The electrode of claim 1, wherein the first electrolyte comprises a salt selected from a lithium salt or a zinc salt, or combination thereof.

6. The electrode of claim 1, wherein the first electrolyte comprises from about 1% to about 40% by weight of the passivation layer on a dry basis and the polymeric material comprises from about 60% to about 99% by weight of the passivation layer on a dry basis.

7. The electrode of claim 1, wherein the polymeric material comprises at least one high molecular weight polymer having a molecular weight from about 50,000 to about 10,000,000 g/mol.

8. The electrode of claim 7, wherein the polymeric material comprises a poly(N-isopropylacrylamide), a polyacrylamide, a poly(2-oxazoline), a polyethyleneimine, a poly(acrylic acid), a polymethacrylate, a poly(ethylene glycol), a poly(ethylene oxide), a poly(vinyl alcohol), a poly(vinylpyrrolidine), a poly(acrylonitrile) and copolymers thereof, or combinations thereof.

9. The electrode of claim 1, wherein the polymeric material comprises a cross-linked polymer formed from one or more hydrophobic monomers.

10. The electrode of claim 9, wherein the polymeric material comprises the reaction product of two or more of the following: (i) at least one polyfunctional crosslinking monomer including at least two free-radically polymerizable functional groups, (ii) at least one long chain monofunctional monomer, and (iii) at least one fluorinated monomer.

11. The electrode of claim 10, wherein the at least one polyfunctional crosslinking monomer comprises a long chain aliphatic monomer having from about 6 to about 40 carbon atoms, and wherein the at least one long chain monofunctional monomer has from about 6 to about 40 carbon atoms.

12. The electrode of claim 10, wherein the at least one fluorinated monomer has from about 6 to about 40 carbon atoms and from about 3 to about 40 fluorine atoms.

13. The electrode of claim 9, wherein the polymeric material is devoid of fluorine atoms.

14. The electrode of claim 1, wherein the electrode has not received an initial charge.

15. An electrochemical cell, comprising:
(i) an anode comprising an active anode species;
(ii) a cathode comprising an active cathode species; and
(iii) an aqueous-based electrolyte composition positioned between and in contact with the anode and the cathode;
wherein at least the anode includes a first passivation layer comprising a first polymeric material and at least a first electrolyte distributed throughout the first polymeric material, the first passivation layer being positioned between the active anode species and the aqueous-based electrolyte composition.

16. The electrochemical cell of claim 15, wherein the cathode includes a second passivation layer comprising a second polymeric material and at least a second electrolyte distributed throughout the second polymeric material, the second passivation layer being positioned directly or indirectly between the active cathode species and the aqueous-based electrolyte composition.

17. The electrochemical cell of claim 15, wherein the aqueous-based electrolyte composition comprises a gel polymer electrolyte (GPE) having a cross-linked three-dimensional polymer network, an electrolyte absorbed by the GPE, and water.

18. A method of forming an electrode, comprising:
(i) providing or forming an electrode-composition including an active electrode species, wherein the electrode-composition comprises a first surface;
(ii) providing or forming a passivation-composition comprising a mixture of (a) a polymeric material and at least a first electrolyte in a liquid medium or (b) monomers and at least a first electrolyte in a liquid medium;
(iii) coating at least a portion of the first surface with the passivation-composition to provide a liquid-containing pre-passivation layer on at least a portion of the first surface; and
(iv) at least one of drying or radically-curing the liquid-containing pre-passivation layer to form a passivation layer comprising a dry mixture of a cured polymeric material and the first electrolyte.

19. The method of claim 18, wherein at least one of drying or radically-curing the liquid-containing pre-passivation layer comprises radically-curing an aqueous composition of the mixture of monomers, and wherein the mixture of monomers comprises two or more of the following: (i) at least one polyfunctional crosslinking monomer including at least two free-radically polymerizable functional groups, (ii) at least one long chain monofunctional monomer, and (iii) at least one fluorinated monomer.

20. A method of forming an electrochemical cell, comprising:
(i) providing or forming an anode comprising a first passivation layer defining a first anode-surface;
(ii) providing or forming a cathode; and
(iii) positioning an aqueous-based electrolyte composition between and in contact with the first anode-surface and the cathode.
